(19) United States
(12) Patent Application Publication
(10) Pub. No.: US 2015/0371212 A1
(43) Pub. Date: Dec. 24, 2015

(54) INTEGRATED TRANSACTION AND ACCOUNT SYSTEM

(71) Applicant: JUST PUSH PAY, LLC, Waxhaw, NC (US)

(72) Inventors: Joseph GIORDANO, Waxhaw, NC (US); Randall TROST, Lynchburg, VA (US)

(21) Appl. No.: 14/763,584

(22) PCT Filed: Jan. 27, 2014
(86) PCT No.: PCT/US14/13213

§ 371 Date: Jul. 27, 2015

Related U.S. Application Data
(60) Provisional application No. 61/756,999, filed on Jan. 25, 2013.
(60) Provisional application No. 61/915,508, filed on Dec. 12, 2013.

(51) Int. Cl. G06Q 20/32; H04W 12/06; H04W 4/02; G06Q 20/40; G06Q 20/38

(52) U.S. Cl. CPC G06Q 20/3224; G06Q 20/4014; G06Q 20/385; H04W 4/02; H04W 12/06

(57) ABSTRACT

A method of transferring electronic funds from a user may include displaying a user code and entering user code on the user's mobile computing device or on a payer's terminal. The payer's terminal is identified and the payee may be determined. The terminal and payer may be matched, and a transaction amount may be received from the payer's terminal. The transaction amount may be displayed to the user for confirmation purposes. A confirmation of the transaction amount is received from the user's mobile computing device. If confirmation is received, the transaction may be completed by debiting the payee's account the transaction amount.

### CROSS REFERENCE TO RELATED APPLICATIONS

This application claims priority to U.S. Provisional Patent Application No. 61/756,999 filed on Jan. 25, 2013 and U.S. Provisional Patent Application No. 61/915,508 filed on Dec. 12, 2013, which are both hereby incorporated herein in their entireties.

### BACKGROUND

Plastic credit cards are prevalent in every day commerce. These plastic cards have a magnetic stripe embedded on one side of the card which identifies the user's account. These cards are used in various transactions such as to pay for purchases by using a credit card, a debit card, or a gasoline charge card. A charge card or a debit card may also be used to transact business with a bank through use of an automated teller machine (ATM). The magnetic stripe card is capable of storing data by modifying the magnetism of magnetic particles embedded in the stripe. The data stored on the magnetic stripe may be sensed or read by swiping the stripe past a read head. The analog waveform obtained by sensing the magnetic stripe must undergo a process known as decoding to obtain the digital information stored in the magnetic stripe of the card. Conventional magnetic stripe card readers are comprised of both relatively simple sensing components as well as the more costly and complex decoding and communication components. The single requirement for use of the magnetic stripe is that the card be physically used at the credit card reader. If a consumer does not have his card with him, then he may not complete the transaction with the user's credit account.

Although magnetic stripe cards are universally used by merchants, there is no way for an individual to take advantage of the card to receive a payment without physically having the plastic credit card with him. For example, an individual may be at a merchant and owe money for a transaction, but not physically have his credit card with him (or not want to carry his credit card). It would be convenient to be able to use a credit card or a debit card to pay the transaction without physically having to present the credit card. However, there is presently no way for an individual to send payment to an individual or merchant without having to physically present the credit card.

### SUMMARY

To address the above-presented problems, a method of transferring electronic funds is disclosed herein according to various embodiments. A user is able to transfer funds without having to physically have to have a credit card. The user or merchant may indicate the desire to transfer funds, such as when the user is buying a product at a store. The user may receive and enter a code into the merchant's terminal (or into the user's mobile device). The code is then verified by the server upon receipt and the transaction may be then confirmed on the user's mobile device. When confirmed, the server then may transfer the electronic funds from the users account to the merchant (or individual).

According to one embodiment, a method of transferring electronic funds from a user may include generating and displaying a user code and entering user code on the user's mobile computing device or on a payer's terminal. The payer's terminal is identified and payee may be determined. The geographic location of the mobile computing device of the payee may be determined. The terminal and payer may be matched, and a transaction amount may be received from the payer's terminal. The transaction amount may be displayed to the user for confirmation purposes. A confirmation of the transaction amount is received from the user's mobile computing device. If confirmation is received, the transaction may be completed by debiting the payee's account the transaction amount.

According to another embodiment, a method of transferring electronic funds from a user to a merchant may include: authenticating a user to perform a transaction using a mobile computing device of the user; receiving an identification of a geographical location of the user's mobile computing device; generating a user code, by a server, associated with the geographical location of the user's mobile computing device; storing the user code at the server; transmitting the user code from the server to the user's mobile computing device so that the user can enter the user code into a terminal of a merchant; receiving, at the server, a terminal code from the terminal, wherein the terminal code is entered into the terminal; determining, by the server, if the user code matches the terminal code; sending authorization to the terminal in response to determining that the terminal code matches the user code; receiving a transaction amount and a terminal identifier from the terminal; determining a geographic location of the terminal based on the terminal identifier; matching the geographic location of the terminal with the geographical location of the user's mobile computing device; sending a request to the user's mobile computing device to approve the transaction; receiving approval from the user's mobile computing device to authentication the transaction; and debit user's account of the transaction amount and pay merchant the transaction amount.

According to yet another embodiment, a method of transferring electronic funds, the method comprising: receiving an identification of a geographical location of a user's mobile computing device; generating a user code, by a server, associated with the geographical location of the user's mobile computing device; storing the user code at the server; receiving, at the server, a terminal code from the terminal, wherein the terminal code is entered into the terminal by the user; determining, at the server, if the user code matches the terminal code; receiving a transaction amount and a terminal identifier from the terminal; determining a geographic location of the terminal based on the terminal identifier; matching the geographic location of the terminal with the geographical location of the user's mobile computing device; receiving approval from the user's mobile computing device to authentication the transaction; and debit user's account of the transaction amount and initiate payment of merchant the transaction amount.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 illustrates a block diagram of a family of accounts for each user used to enable various processes for processing a transaction according to one embodiment of the present invention.

FIG. 2 illustrates a flow chart of a business registration according to an embodiment.

FIG. 3 illustrates a flow chart of a personal registration according to an embodiment.

FIG. 4 illustrates a flow chart of a preferred supplier registration process according to an embodiment.

FIG. 5 illustrates a flow chart for registering the payment accounts. At step 510, account data is entered.

FIG. 6 illustrates a flow chart of a method of determining a transaction history according to an embodiment.

FIG. 7 illustrates a flow chart for setting up an instant credit account according to an embodiment.

FIG. 8 illustrates a system diagram according to an embodiment.

FIGS. 9A-9B illustrates a flow chart of a method of a payments routing engine according to an embodiment.

FIG. 10 illustrates a flow chart of a method of accepting payments according to an embodiment.

FIG. 11 illustrates a flow chart for making a payment with a registered account according to an embodiment.

FIG. 12 illustrates a flow chart for making a payment request according to an embodiment.

FIG. 13 illustrates a flow chart for making a payment from a payment request according to an embodiment.

FIG. 14 illustrates a flow chart of accepting payment at retail POS according to an embodiment.

FIG. 15 illustrates a flow chart of a three party payment method according to an embodiment.

FIG. 16 illustrates a flow chart for tracking and budgeting process according to an embodiment.

FIG. 17 illustrates a flow chart for facilitating a transaction according to an embodiment.

FIG. 18 illustrates a flow chart for facilitating a transaction according to another embodiment.

FIG. 19 illustrates an interface for processing a transaction according to some embodiments of the present invention.

FIG. 20 illustrates an interface for processing a transaction according to some embodiments of the present invention.

FIG. 21 illustrates an interface for processing a transaction according to some embodiments of the present invention.

FIG. 22 illustrates an interface for processing a transaction according to some embodiments of the present invention.

FIG. 23 illustrates an interface for processing a transaction according to some embodiments of the present invention.

FIG. 24 illustrates an interface for processing a transaction according to some embodiments of the present invention.

FIG. 25 illustrates an interface for processing a transaction according to some embodiments of the present invention.

FIG. 26 illustrates an interface for processing a transaction according to some embodiments of the present invention.

FIG. 27 illustrates an interface for processing a transaction according to some embodiments of the present invention.

FIG. 28 illustrates an interface for processing a transaction according to some embodiments of the present invention.

FIG. 29 illustrates an interface for processing a transaction according to some embodiments of the present invention.

FIG. 30 illustrates an interface for processing a transaction according to some embodiments of the present invention.

FIG. 31 illustrates an interface for processing a transaction according to some embodiments of the present invention.

FIG. 32 illustrates an interface for processing a transaction according to some embodiments of the present invention.

FIG. 33 illustrates an interface for processing a transaction according to some embodiments of the present invention.

FIG. 34 illustrates an interface for processing a transaction according to some embodiments of the present invention.

FIG. 35 illustrates an interface for processing a transaction according to some embodiments of the present invention.

FIG. 36 illustrates an interface for processing a transaction according to some embodiments of the present invention.

FIG. 37 illustrates an interface for processing a transaction according to some embodiments of the present invention.

FIG. 38 illustrates an interface for processing a transaction according to some embodiments of the present invention.

FIG. 39 illustrates an interface for processing a transaction according to some embodiments of the present invention.

FIG. 40 illustrates an interface for processing a transaction according to some embodiments of the present invention.

FIG. 41 illustrates an interface for processing a transaction according to some embodiments of the present invention.

FIG. 42 illustrates an interface for processing a transaction according to some embodiments of the present invention.

### DETAILED DESCRIPTION OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, a class may define an abstract characteristic of a thing or object, such as a group of code or instructions for performing a particular operation or function. The abstract characteristics may include characteristics of the thing or object, for example attributes, fields or properties, behaviors, such as functions or methods that can be performed by the class. An object is a particular instance of a class. The set of values of the attributes of a particular object is the state of the object. The object includes the state and the behavior that is defined in the object's class. A method is an object's abilities or functions the object can perform.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Some terms may be used herein according to some embodiments of the present invention. A business user may be a business client of a service provider. A personal user may be a consumer user of a service provider that makes payments to the business user(s). A service provider may be an entity that provides the application and support of services. A banking platform provider may be an entity that provides technical platform and support services for prepaid debt accounts and cards. A payment gateway provider may be an entity that provides a real-time data transaction capture capability that connects to various payment networks and banks to enable payment transactions and support services. A processing partner or underwriter may be an entity that provides merchant underwriting, chargeback, and merchant processing support services. An acquiring bank partner may be an entity that provides acquiring bank services (including overnight funding of incoming consumer credit and debit card payments to the designed virtual prepaid debt account for business clients of service provider).

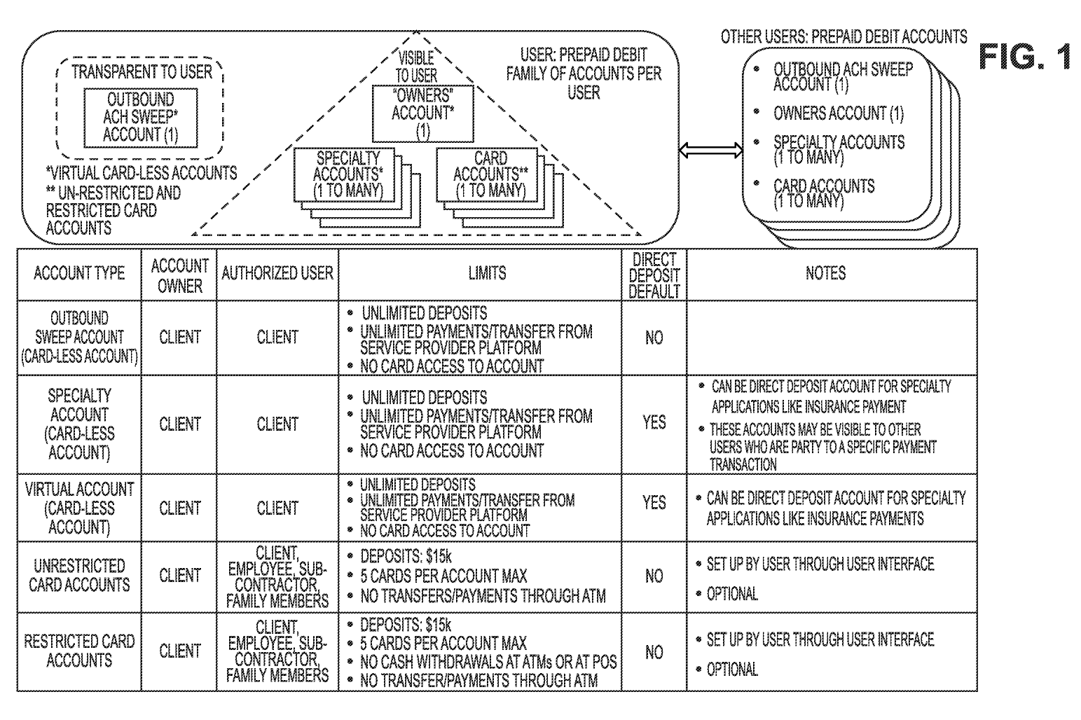

FIG. 1 illustrates an overview of a family of accounts for each user according to one embodiment of the present invention. FIG. 1 will be referred to in the rest of the Figures. FIG. 1 depicts a family of accounts utilized to uniquely service the Client Business User, or each Personal Consumer User. Each User will receive multiple Virtual Accounts used for specific purposes. In the case of a Business User, one of the virtual accounts will be the “Owners Account” which is where incoming payment transactions from other users are deposited, transfers from other external bank accounts are deposited, or transfers to other external bank accounts are debited. All of the virtual accounts are card-less account so that there is no risk of card-based fraudulent card activity accessing the funds in the account. In the case of a Consumer Personal User, the Owners Account would be the user's direct deposit account where their employer would deposit their paycheck. The Owners Account can only be accessed through the service provider's system where authentication is the most robust, and where transactions initiated over a certain amount are subject to additional advanced authentication techniques. In addition to the Owner's Account, the User may request additional card accounts for other authorized user's of the account. Due to the risk of card-based fraud, card accounts would have limited balances to minimize losses in the event of a compromise. In the case of a Business User, this would be an employee or sub-contractor. In the case of Personal User, this would be another family member. The service provider's system will enable transfers between the Owner's various accounts by updating balances in the Bank Provider Platform. Additionally, each user will receive a virtual outbound ACH sweep account to enable real-time accounting of ACH settled transactions, and other virtual accounts used for specialty processing. For example, 3 and 4 party insurance transactions may use a specialty holding account for insurance payments. It should be noted that funds can be put into a virtual account while funds are being settled to it (or by transfer from another account).

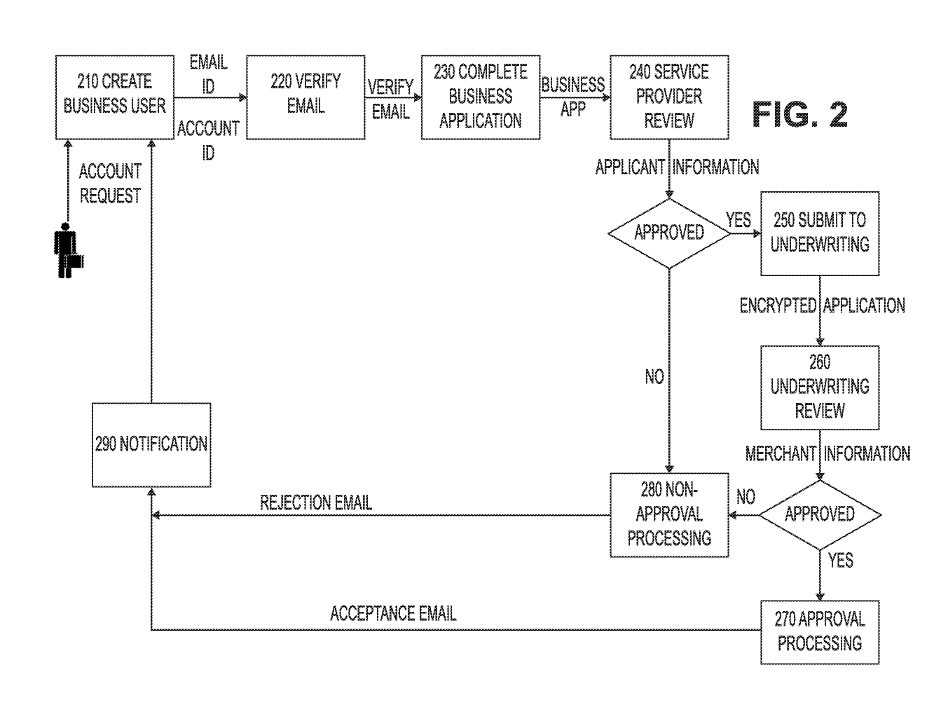

Referring to FIG. 2, a business registers for an account. To do this, a business user selects “business registration” (step 210). The business user profile may include information such as name, email, password, confirms password, mobile phone, home phone, home address, city, state, zip, agrees to terms, selects continue, security questions and answers. At step 220, a service provider sends an email verification email provided by the user. The personal user opens the email and clicks on “verify email address” button (or the like). The service provider updates an email status to “verified” and sends the user a notice that email has been verified.

At step 230 the business user:

1—enters company information: years in business, legal name, doing-business-as (“DBA”) name, legal address (city, state, zip code, etc.), mailing address (city, state, zip code, etc.), office phone, DBA phone, website address, fax, or any other information associated with the company;

2—enters legal and tax information: principal name/names, government ID (Driver's License), date of issuance, county and state of issuance, principle date of birth, business license number, tax ID number, company annual sales, legal structure, and any other legal or tax information associated with the company;

3—enters reference information: bank reference information (account number, routing number, account type), bank contact with phone number, at least one trade reference with phone number, and may enter a second trade reference and up to two trade/business associations.

4—attaches documents: a recent bank statement and one or more of the following documents (business license, financial statements, other documents as requested by service provider)

5—provides electronic signature, agrees to terms of use, and provides Social Security Number. Special processing occurs as follows:

The service provider creates the virtual (card-less) prepaid owners account by an API call to the banking platform provider. The routing number and account number for the business' virtual prepaid owner's account will be written to the application as the account where the acquiring bank partner deposits funds each night (for payment coming to the business from other business users and other personal users). The virtual account number and its associated bank account number for the virtual prepaid debit account are both tokenized with the banking platform provider so that ACH transfers and account-to-account transfers may be made in and out of the account. The Tokens are stored by the service provider.

Bank account numbers provided as bank reference numbers are tokenized with banking platform provider (by API call) so that the business user may transfer funds electronically in and out of any of their prepaid debit accounts provided by service provider in the future. The service provider stores a token to access the tokenized account.

Social security numbers are written to the business application in PDF format and encrypted.

The business application is immediately stored in an encrypted PDF format on a non-customer-facing server. The encryption password is generated dynamically and is provided by voice communication to the processing partner or underwriter. The encryption key methodology is changed monthly and the encryption key itself is different for each user application.

At step 240, a service provider review occurs. The service provider reviews application by checking authenticity of business through information provided directly by business user, by reviewing supporting documentation (bank statements, articles of incorporation, financial statements, etc.), and by contacting trade references. The service provider approves or rejects the application using the admin screens, and will attach a document to the electronic application that support the decision.

At step 250, submission to underwriting occurs. If approved by the service provider, account status is updated to “processing”. The service provider will email encrypted application to processing partner (or underwriter), and will provide the encryption password for the application to the processing partner on underwriter by phone call.

At step 260, underwriter reviews merchant account including credit history of business and principals.

At step 270, approval processing occurs. If underwriter approves application, service provider updates status to “approved”. If approved, service provider will set-up a virtual card-less prepaid debit account used for outbound ACH transactions. This virtual account number and the associated bank account number (for ACH transactions) will be tokenized with banking platform provider. Service provider will store tokens. If approved, service provider will set up a card account by API call to banking platform provider, and a card for the first principal entered by the business. service provider will send out the card, and tokenize the card account number with banking platform provider and payment gateway provider, and will tokenize the associated bank account number with banking platform provider

At step 280, non-approval processing may occur. If applicant doesn't meet service provider or underwriting criteria, underwriter will provide rejection notice “rejected” or information request notice to service provider. The service provider will appropriately update status to “rejected” or “draft”.

At step 290, notification of acceptance or rejection occurs. If business is approved, business user will receive an approval email. If more information is needed, business user will receive an email requesting information and will be able to update their application. If rejected, business user will receive a rejection email.

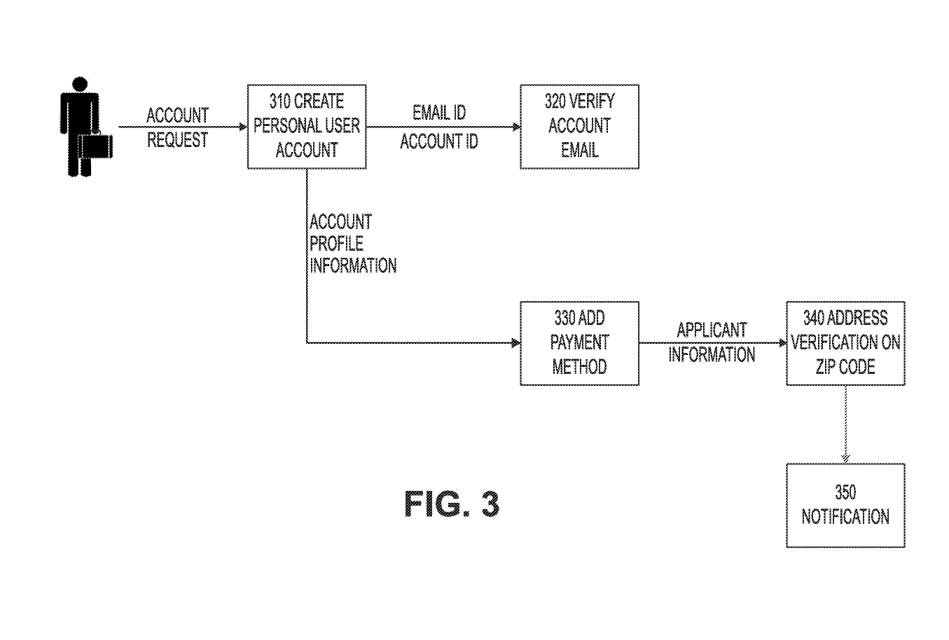

Turning to FIG. 3, personal user registration is described. At step 310, a personal user account is created. The personal user selects “personal registration”. The personal user profile information: Name, email, password, password confirmation, mobile phone, home phone, home address, city, state, zip, agrees to terms, continue selection, security questions and security answers.

At step 320, service provider sends email verification email provided by user. personal user opens email, clicks on “Verify Email Address” button; service provider updates email status to “verified” and sends the user a notice that email has been verified.

At step 330, a payment method is added. The personal user selects Card type, Debit or Credit, nickname, Payment Brand, Card Number, expiration, billing zip, default card, and clicks add payment card. If account is valid, service provider tokenizes card accounts with payment gateway provider and bank accounts with banking partner providers. Service provider performs 340 Account Verification. Once verified, accounts are ready to be used for payments (card accounts), and transfers (external bank accounts)

At step 340, account verification occurs. If payment method is a credit or debit card, service provider sends an API call to payment gateway provider to validate card number (mod 10 check), and validate that billing zip code is the same as the billing zip code in the bank's system. If payment method is an external bank account number, service provider tokenizes bank account number with the banking platform provider by making an API call. Additionally, banking platform provider will make a trial deposit into the user's bank account for the user to verify. Once verified, the account can be used for transfers.

At step 350, notification occurs where service provider sends approval email to personal user.

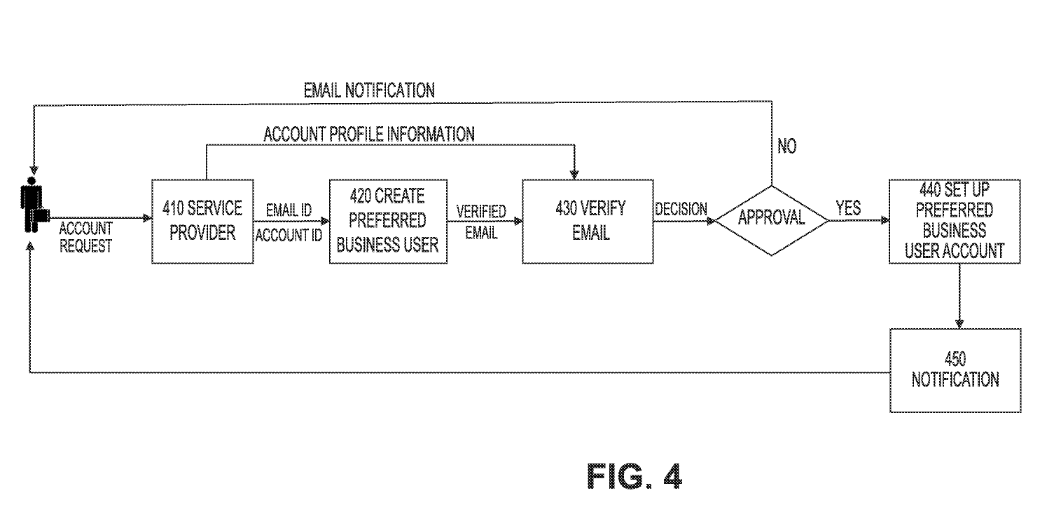

FIG. 4 illustrates a preferred supplier registration process. At step 41, service provider offers a preferred arrangement and updates “Preferred Business” status in system. At step 42, preferred business user selects “preferred business Registration”. Preferred business user profile information may include: name, email, password, password confirmation, mobile phone, home phone, home address, city, state, zip, agrees to terms, security questions and answers. Preferred business also determines whether they want funds from incoming payments deposited in their external bank account or in their owners virtual prepaid debit account.

At step 430, service provider sends email verification email provided by user. Preferred business user opens email, clicks on “Verify Email Address” button; service provider updates email status to “verified” and sends the preferred business user a notice that email has been verified.

At step 440, the preferred business user account is set up. Service provider creates the virtual (card-less) prepaid owners account by API call to the banking platform provider. The routing number and account number for the business' virtual prepaid owner's account will be written to the application as the account where the acquiring bank partner deposits funds each night (for payment coming to the preferred business from other business' and other personal users). The virtual account number and its associated bank account number for the virtual prepaid debit account are both tokenized with the banking platform provider so that ACH transfers and account-to-account transfers may be made in and out of the account. The tokens are stored by the service provider.

The service provider uses an API call with banking platform provider to set-up preferred business' external bank account number that is provided. Bank account numbers may be tokenized with the banking platform provider so that the preferred business may receive payments. The service provider stores a token to access the tokenized account.

The service provider sets-up a virtual card-less prepaid debit account used for outbound ACH transactions by API call with banking platform provider. This virtual account number and the associated bank account number (for ACH transactions) will be tokenized with banking platform provider. The service provider will store tokens.

At step 450, service provider sends email to preferred business indicating that they can use the system and receive payments.

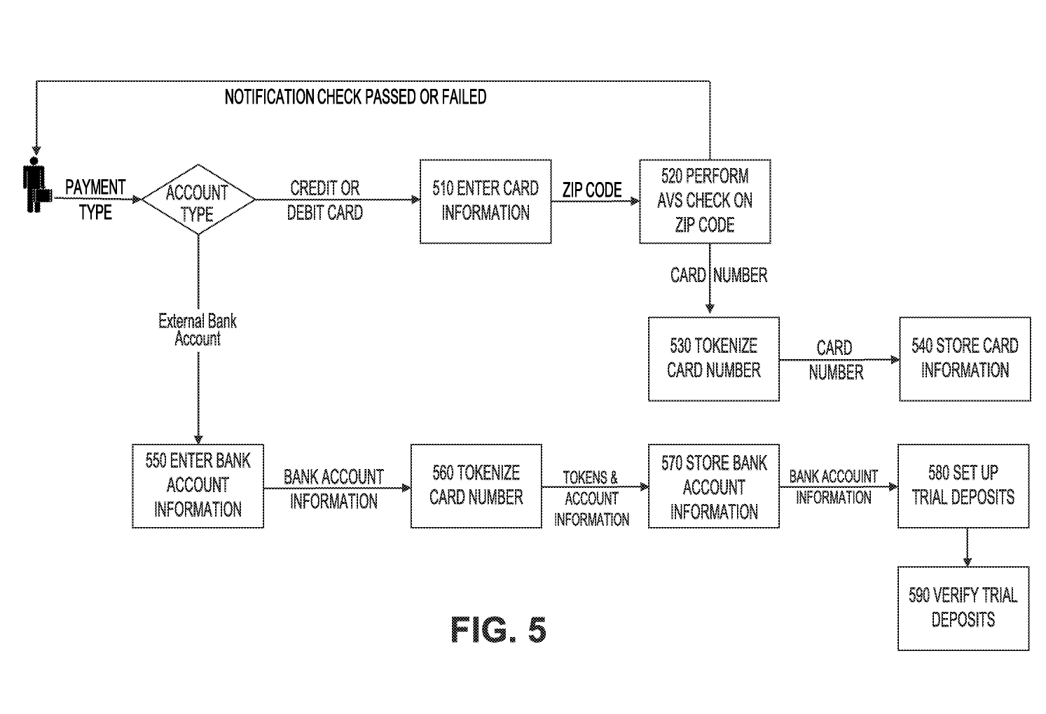

FIG. 5 illustrates registering the payment accounts. At step 510, account data is entered. If card account:
From the Account screen, select Add a Credit or Debit Card
Select/Enter: card type either credit or debit, enter the account nickname, Payment Network (Visa, Discover, MasterCard, American Express), Card Number, Expiration Date from the month and year drop down boxes, Billing zip code, default card indicator (y/n)
Select Add Payment Card.

At step 520, perform AVS check on zip code. If Card Account, through an API call with payment gateway provider, compare the billing zip code provided with the billing zip code on file with the user's bank. If a match, proceed to next step.

At step 530, tokenize account numbers. If an external bank account, then tokenize the account number with banking platform provider.

At step 540, store card information. If an external bank account, then store Token, last 4 digits of account number, bank name and routing number. Wipe bank account number from the system. If a card account, then store Token, card type, nickname, payment network brand, last 4 digits of card account number, expiration date of card, billing zip code, and default card indicator.

At step 550, enter bank account information. From Account Screen, select add other account. Select/Enter account number, routing number.

At step 560, tokenize card number. Get Token from Banking Platform Provider and wipe bank account from the system (except for the last 4 digits of account number)

At step 570, store bank account information. Store Token, last 4 digits of account number, bank name and routing number.

At step 580, set up trial deposits. If external bank account, the execute trial deposit process by making a small deposit into the bank account so that the user can verify the amount of the deposit to prove they are the owner of the account.

At step 590, verify trial deposits. If external bank account, require the user to enter the amount of the deposit to verify their ownership of the account.

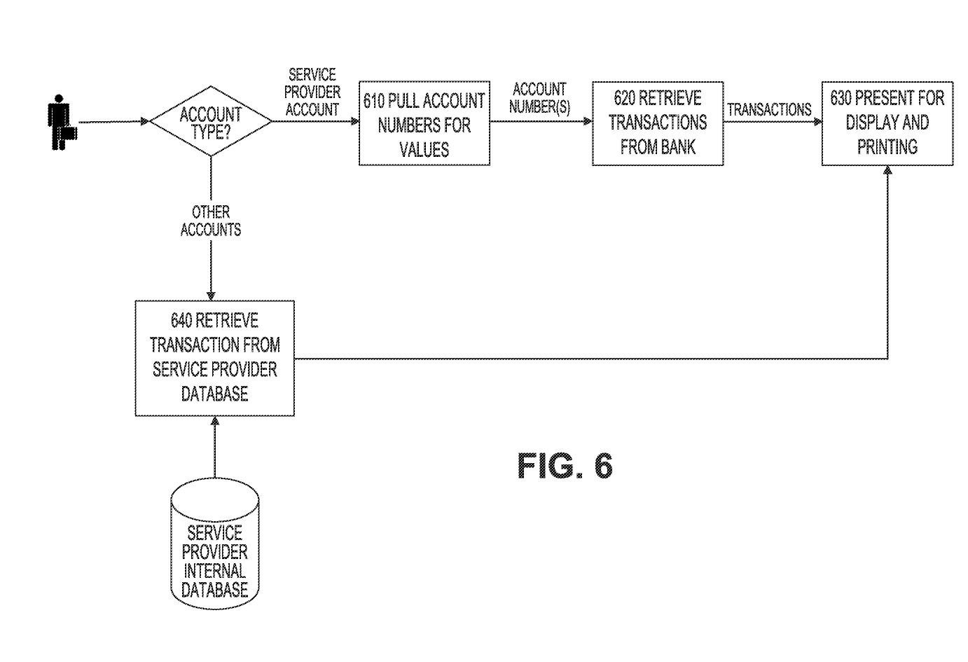

FIG. 6 provides transaction history. At step 610, if User selects the service provider Prepaid Debit Account Activity, service provider will send Account Token for each account to the Vault to look-up account numbers by using an API call to banking platform provider. If User selects Payment Activity, service provider will look-up all accounts associated with user in service provider database (Prepaid Debit accounts and other registered card and bank accounts).

At step 620, retrieve transaction from the bank. If User selects service provider Prepaid Debit Account Activity, service provider WILL retrieve detail transaction data including balance information via an API call to banking platform provider for all Prepaid Debit Accounts owned by User. This is a real-time account so all balances will be update to date real-time and it will include all transactions against the account (including transactions that do not occur in the platform such as card transactions at a retail POS, ATM transactions, and bank branch transactions).

At step 630, Present for Display, Printing, and Downloading. service provider will display transactions on the screen with options to determine how many transactions per screens, print or download in friendly format.

At step 640, Retrieve transactions from Service Provider Database. If User selects Payment Activity, service provider will retrieve payment and transfer activity data for Prepaid Debit Account for all activity occurring within the service provider platform. This is a real-time platform so all transactions occurring in the platform will be available real-time. However, activity such as card transactions at a retailers POS, ATM transactions, and bank branch transactions (that do not occur in the platform) would not be available on this report, but would be available on the Prepaid Debit Account Activity for all Prepaid Debit Accounts.

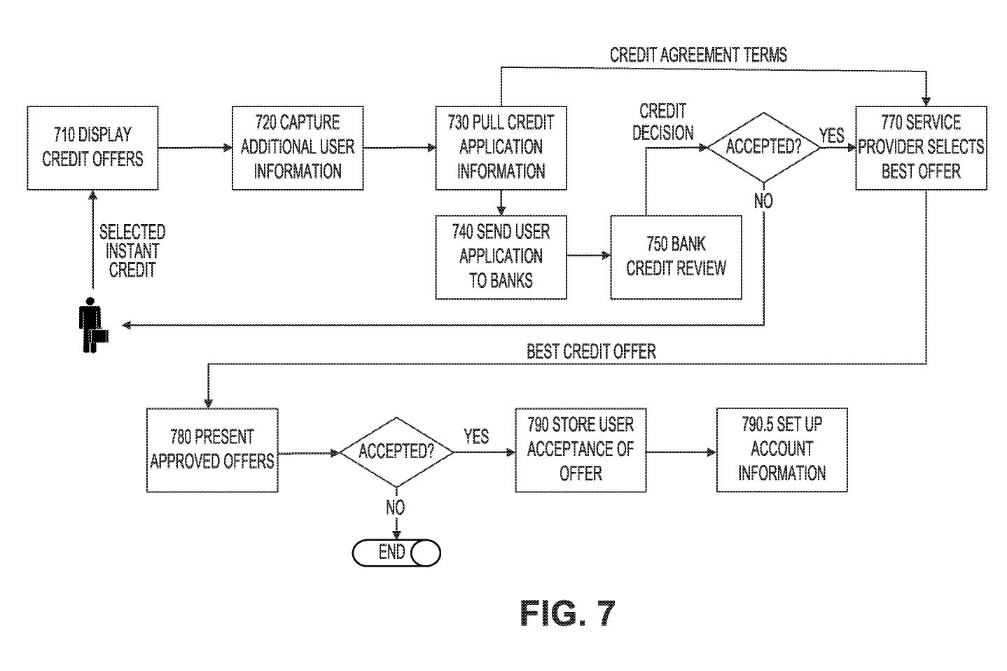

FIG. 7 illustrates setting up an instant credit account. At step 710, credit offers are displayed by an API call to banks and other third parties, capture potential offers available in the market place.

At step 720, Capture additional User Information. The User applies for Instant Credit.

When user selects a certain offer, capture additional information including SSN, amount of credit needed, acknowledgement of credit check and other disclosures, and desired date of repayment each month.

At step 730, Pull Credit Application Information. Service provider will check User's credit score. If credit score is too low, the customer will receive a decline message (760) and the process ends

At step 740, Send User Information to Bank(s). Based on credit score category, service provider will match User with best bank offers and send application to bank(s) by API call for bank(s) where there is a potential match. Service provider will merge the User's information from the initial registration process including name, address, and email address, along with additional information captured in 720.

At step 750, Bank Credit Review and Decision occurs. Banks will receive application information by API, and will make a credit decision. Banks will send a credit offer for the User to consider, or a rejection notification (by API).

At step 760, Send Rejection Notification. If rejected, service provider will provide a rejection notice with required legal and regulatory disclosures.

At step 770, service provider selects best approved offers. If the customer is approved, service provider will select the best offer(s) based on the service provider margin and the consumer price.

At step 780, Present Approved Offers. Service provider will then present the offer(s) to the user and display the terms of the agreement. The customer can accept or refuse the offer. If User declines all offer(s), the process ends.

At step 790, Store User acceptance of Offer. If the User accepts an offer, the acceptance of terms (displayed online) from the bank and service provider will be stored in the system.

At step 795, Set-up Account Information. Service provider will send communication to bank by API that the User has accepted the offer. Service provider will tokenize account data with payment gateway provider if a Visa, MC, or Discover credit card product. If it is a credit account that is only provided through the service provider (not VISA, MC, or Discover branded), then the payment account will be tokenized directly with bank. Service provider will store only the token and the last 4 digits of account in database.

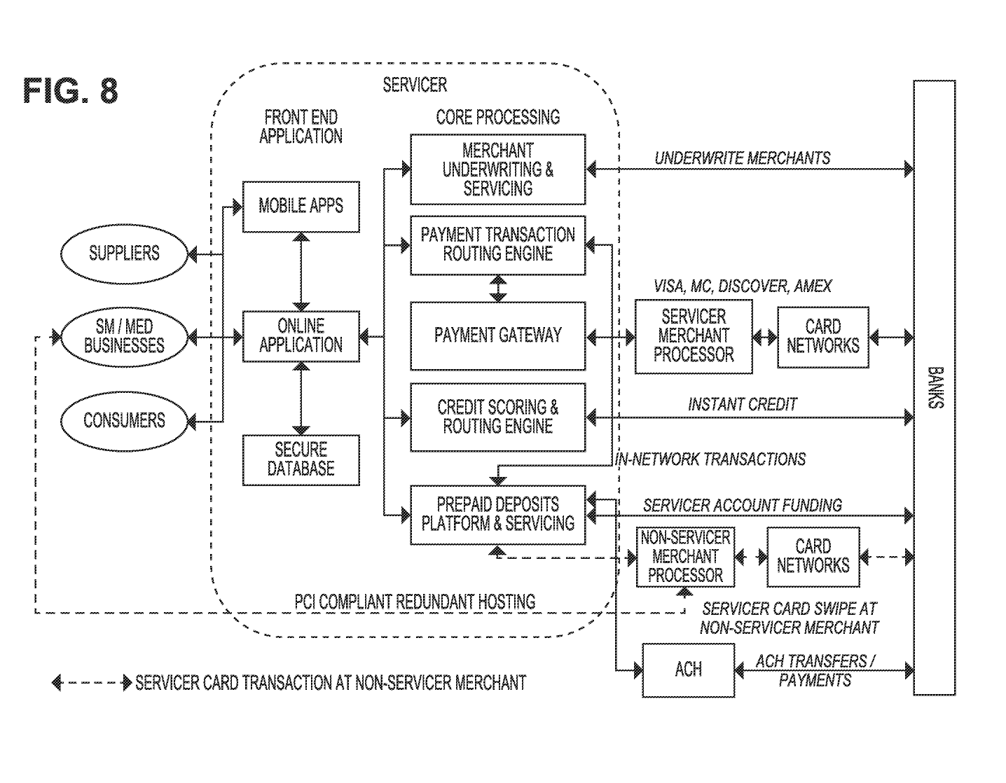

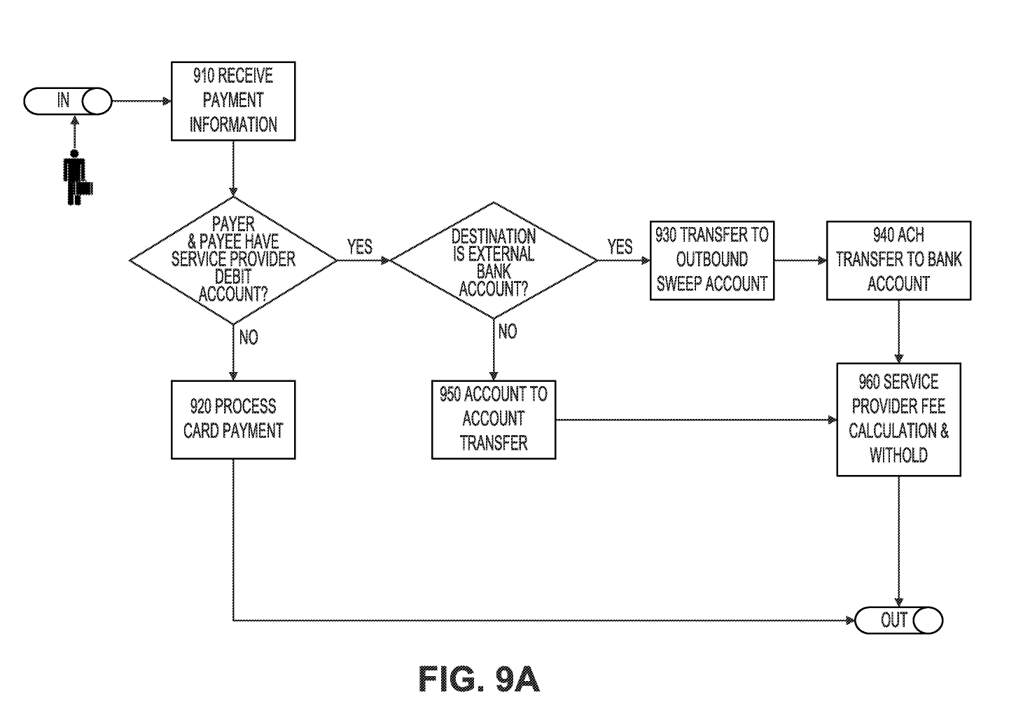

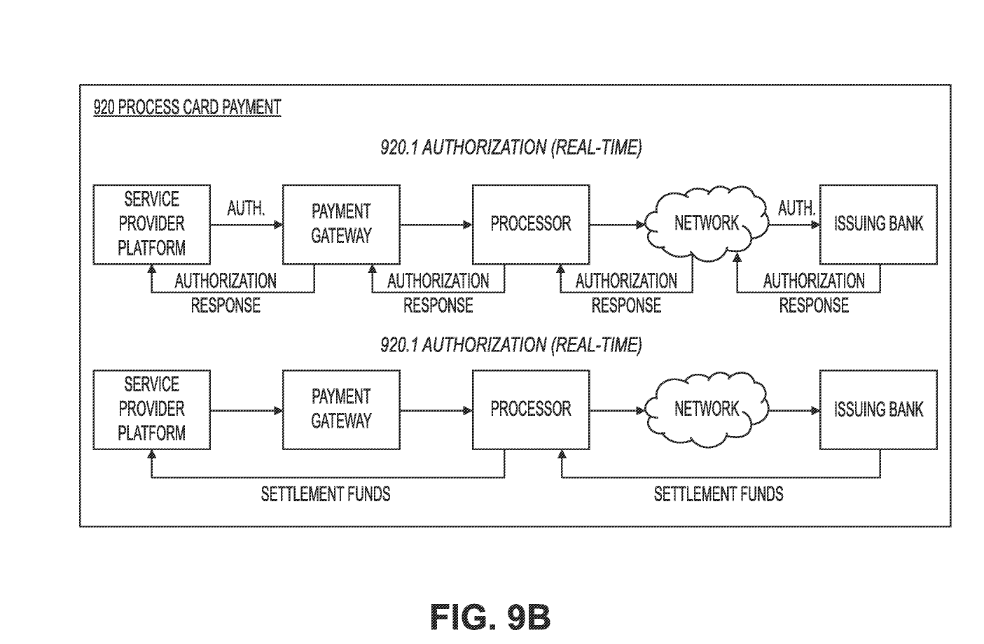

FIGS. 8 and 9 illustrate a payments routing engine.

FIG. 8 illustrates a system diagram according to an embodiment. As illustrated a servicer is disposed between banks and consumers, suppliers, and small/medium businesses (i.e., users and merchants). The user's and merchants interface directly with the servicer over a network, while the service interfaces with banks and other entities over a network.

The servicer has a front end application, which included mobile applications (which run on the users' mobile computing devices), online applications (which operate on user's computing devices), and a secure database. The secure database is accessible to the users and merchants via the online application and mobile applications. As used herein, mobile applications may be those that are installed on users' mobile devices and require authentication for users to use them.

The front end application is in communication with merchant underwriting and servicing, payment transaction routing engine, credit scoring and routing engine, and prepaid deposits platform and servicing.

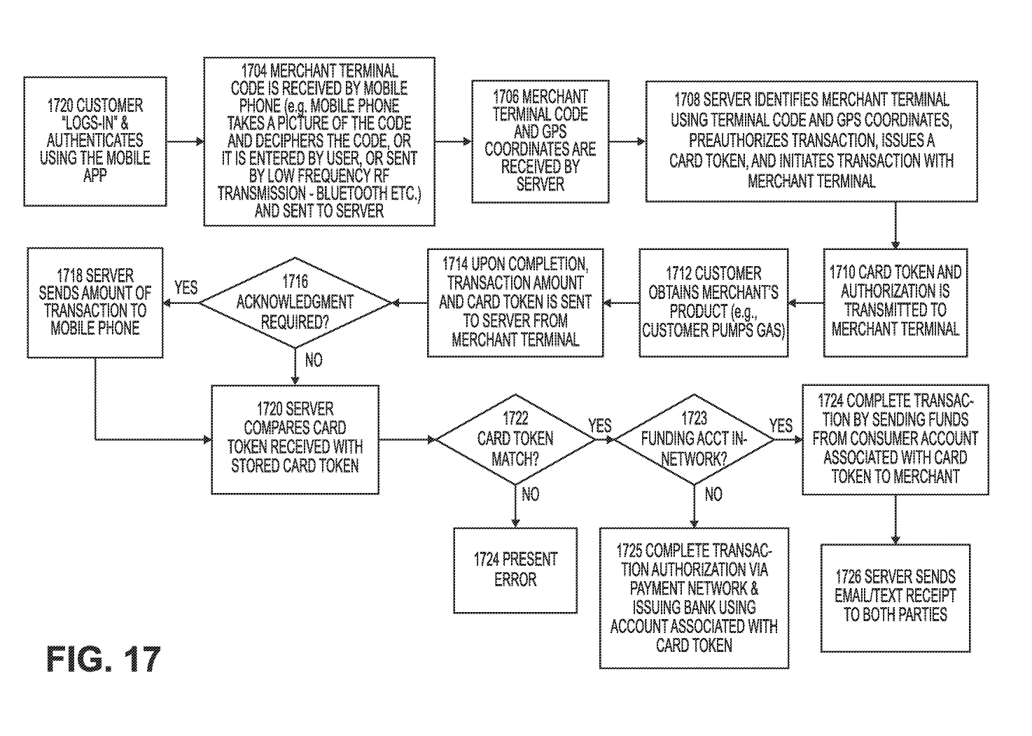

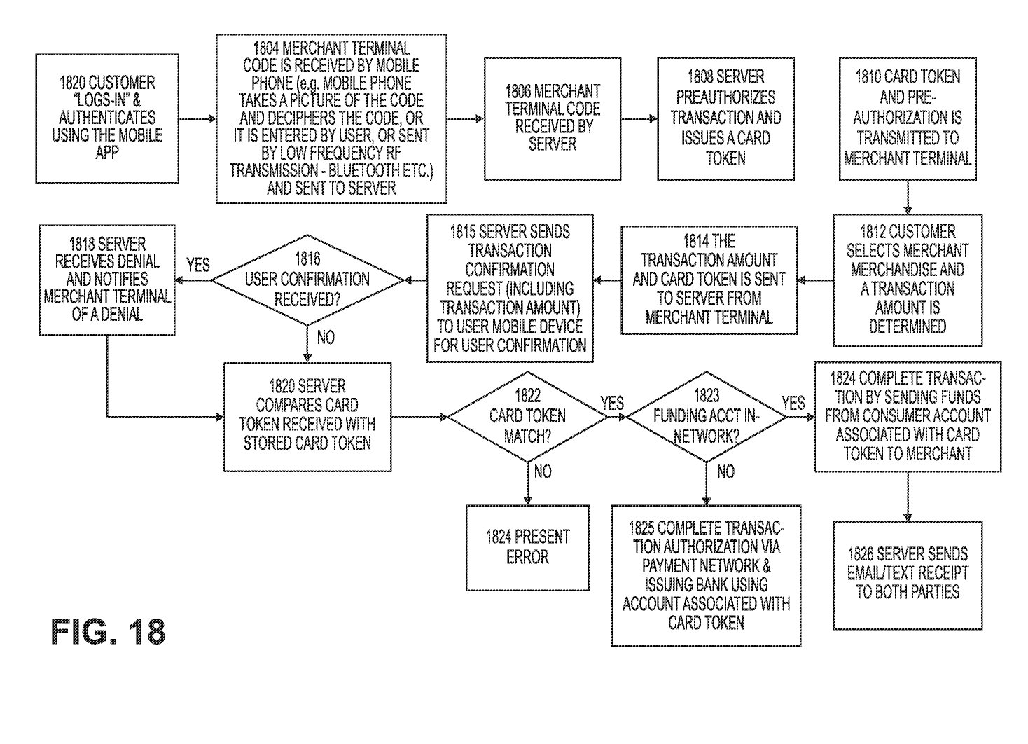

The servicer includes a processor that is configured to perform one or more steps of the flow charts presented herein including those in FIGS. 17 and 18. Additionally, the servicer includes memory to temporarily store and access data during payment processing, such as card tokens, merchant locations based on merchant codes, pending transaction data and the like. The servicer also has a server which is referenced herein and may be one or a series of computing devices which each contain a processor, memory and non-transitory computer readable medium embodying computer instructions to perform the methods disclosed herein.

As illustrated, in-network transactions completely occur within the servicer, as the funds are not requested from the third-party external banks. In this regard, the payment transaction routing engine communicated with the prepaid deposits platform and servicing to transfer moneys between in-network accounts. For transferring of money using external account (e.g., third-party banks), the servicer can work with ACH to perform ACH transfers/payments (for transfers between savings/checking accounts) or using card networks and non-servicer merchant processors to effectuate fund transfers.

Instant credit may occur directly between the credit scoring and routing engine and the banks, and the merchant underwriting and servicing may occur directly between the servicer and the banks to underwrite the merchants.

The payment gateway of the servicer communicated with the servicer merchant processor and with card networks to interface with the banks in some embodiments.

It should be understood that there is a network between the users and the servicer, between the servicer and banks, and between the users and banks. Additionally, other networks are also possible such as within the servicer to perform in-network transfers, and networks such as those to effectuate ACH transfers.

The servicer herein performs the features of the method steps presented herein to act as mediator between the user's and merchants, between merchants and banks, and/or between users and banks.

The database of the servicer can house various transaction data, including all merchant terminal locations, merchant terminal codes, pending transactions, completed transactions, and transactions that have been denied. The servicer can receive data from users mobile applications, including merchant terminal codes and GPS coordinates to determine the location of the user and the merchant terminal. The server of the servicer also may perform various other operations and discussed in the flow charts herein.

FIG. 9 illustrates a flowchart illustrating the method. At step 910, Receive Payment Information. If the payment is from a service provider Prepaid Debit Account to another service provider Prepaid Debit Account, then the system will transfer funds from the Payer's designated Prepaid Debit Account to the Payee's Prepaid Debit Owner's Account by making an API call with the banking platform provider. If the Payee is a preferred business user or for any other user that has a service provider Prepaid Debit Account and for any reason that User has selected “auto transfer” to their external bank account as their preference, then an account to account transfer to the User's outbound ACH Account will take place real-time, and then an ACH transaction will transfer funds to the User's designated external bank account depositing funds in their Prepaid Debit Owner's Account. A fee will be withheld from the Payee's payment and will be transferred to service provider's Prepaid Debit Account. If the Payer is using a card that is not a Prepaid Debit Account provided by service provider, then the transactions will be routed through the payment gateway provider as a Card Payment.

At step 920, Process Card Payment. Process Card transaction through appropriate 3^{rd} party payment network (Visa, MC, Discover)

At step 930, Transfer to Outbound Sweep Account. Transfer funds by updating balances of designated Payer Prepaid Debit Account and Payer's Outbound Sweep (Prepaid Debit Account) by using API call from banking platform provider.

At step 940, ACH Transfer to Bank Account. Transfer funds from Payer's Outbound Sweep Account (Prepaid Debit Account) to Payee's designated External Bank Account. Note: Payer and Payee may be the same person/entity.

At step 950 Account to Account Transfer may occur. Transfer funds by updating balances of designated Payer Prepaid Debit Account and Payee Prepaid Debit Account (Owners Account) by using API call from banking platform provider

At step 960, Service Provider Fee Calculation & withholding: Calculate fee based on user type (personal, business, preferred business). Withhold fee from Prepaid Debit Account (Owners Account) using API call to Banking Platform Provider

At step 921, Transaction Authorization Is shown: Send Authorization request using standard format to Issuing Bank, and Receive Authorization response back near real-time.

At step 922, Transaction Settlement occurs: At end of day, create settlement file by merchant and send to processor. Processor creates settlement file by Issuing Bank. Issuing Bank receives settlement file and processes. Issuing Bank sends funds to Processor. Processor sends funds to Service Provider (In the end implementation, Service Provider will receive funds directly; Initially, funds will be returned directly to Merchant net of fees to processor and processor will pay Service Provider at month end).

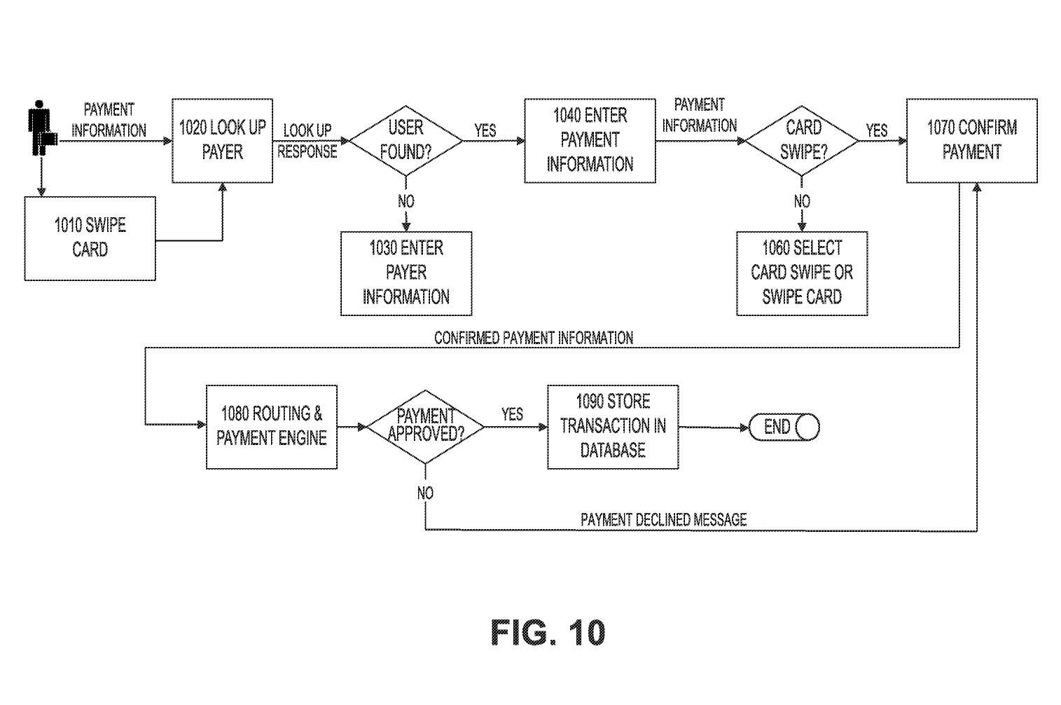

FIG. 10 illustrates accepting payments. At step 1010 swipe card: business or consumer user will swipe their card at any point through step 1060. If the business user is not logged into the system will prompt the user to.

At step 1020, look up payer: service provider requires Payer Name, email address and mobile phone number for sending receipts and servicing the transactions as needed. If Payer is an existing User, Payee can look-up User by entering any portion of Payer's user name, email address, mobile number, or business name if applicable If the payer has been entered into system previously, service provider application will locate the payer and display their name, address, email and phone number. Multiple payers may appear, and then Payee will select the correct payer from the list. Payee will proceed to 1040. If the payer is not found Payee will proceed to 1030 and enter the Payer into the system.

At step 1030 enter payer information: Payee will enter the Payer's Name, email, and mobile number into the service provider application. Service provider will store User Information in the database as an inactive personal user. The User will be able to process a card through the business user by swiping a card but will be unable to access the system themselves until they complete registration and agree to terms of use.

At step 1040, enter payment info: Payee will enter “amount”, and at Payer's option attach an invoice and enter a memo. They must then select a payment method.

At step 1060, Select Card Swipe or Swipe Card. If a card swipe has NOT already been detected, the User will select “Send request for Payment”, or “Accept a Payment by card”. If Card swipe has been detected, then this step is skipped and the application moves to 1070. If “send request for Payment”, then a message will appear for the Payee making the request: “Your request for payment in the amount of —has been sent to—”, and an email will be sent to the Payer with a link to login to the site. If Card swipe has been detected, using the service provider secure card swipe, the User will touch the screen and sign their name with their finger, and confirm their payment by hitting the pay button.

At step 1080, this is previously discussed in FIG. 9.

At step 1090, transaction is stored in a database. The payment transaction will be stored in the service provider database. If the transaction uses a service provider Prepaid Debit Card, the transaction will also be stored by banking platform provider in Banking Platform database.

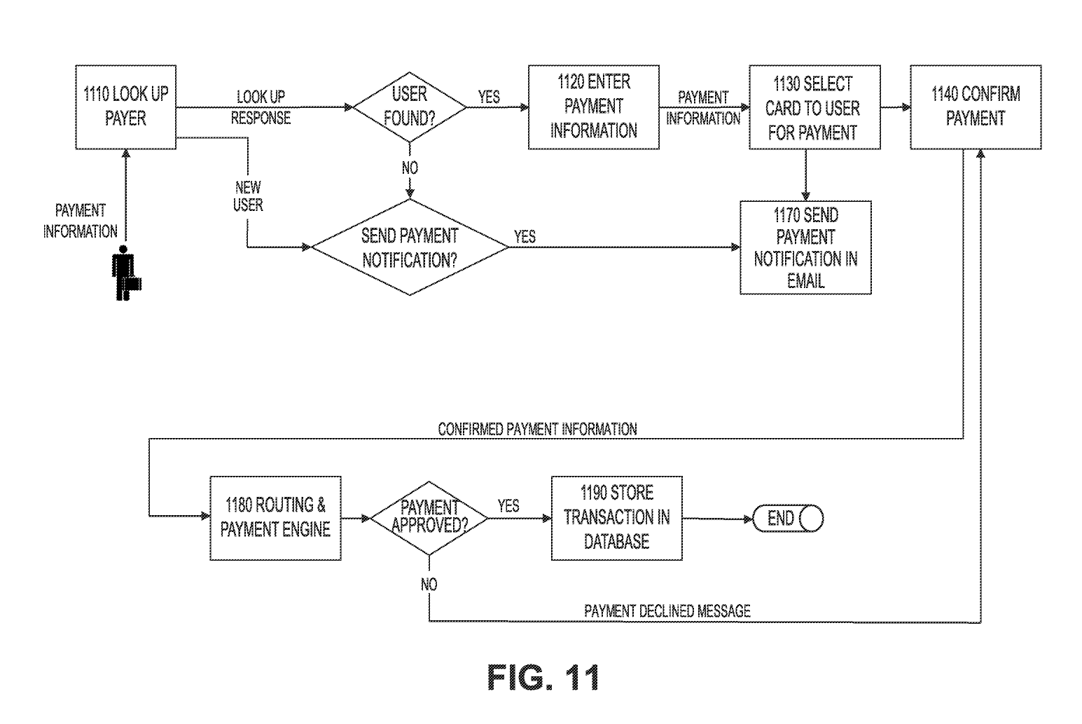

FIG. 11 illustrates making a payment with a registered account. At step 1110, Look Up Payee: service provider requires Payer Name, email address and mobile phone number for sending receipts and servicing the transactions as needed. If Payer is an existing User, Payee can look-up User by entering any portion of Payer's user name, email address, mobile number, or business name if applicable. If the payer has been entered into system previously, service provider application will locate the payer and display their name, address, and email and phone number. Multiple payers may appear, then Payee will select the correct payer from the list. Payee will proceed to 1240. If the payer is not found Payee will proceed to 1230 and enter the Payer into the system.

At step 1120 Enter Payee Information: Payee will enter the Payer's Name, email, and mobile number into the service provider application. Service provider will store User Information in the database as an inactive personal user. The User will be able to process a card through the business user by swiping a card but will be unable to access the system themselves until they complete registration and agree to terms of use.

At step 1130 Enter Payment Information: Payee will enter “amount”, and at Payer's option attach an invoice and enter a memo. They must then select a payment method.

At step 1140 Select Card to Use for Payment: If a card swipe has NOT already been detected, the User will select “Send request for Payment”, or “Accept a Payment by card”. If Card swipe has been detected, then this step is skipped and the application moves to 1270. If “send request for Payment”, then a message will appear for the Payee making the request: “Your request for payment in the amount of —has been sent to—”, and an email will be sent to the Payer with a link to login to the site.

At step 1150 Confirm Payment If Card swipe has been detected, using the service provider secure card swipe, the User will touch the screen and sign their name with their finger, and Confirm their payment by hitting the pay button.

At step 1160 Sent Payment Notification: service provider Platform sends email receipt to Payer

At step 1180 Routing & Payment Engine as previously discussed.

At step 1190 Store Transaction in Database. The payment transaction will be stored in the service provider database. If the transaction uses a service provider Prepaid Debit Card at an external entity, transaction data will also be stored by the banking platform provider.

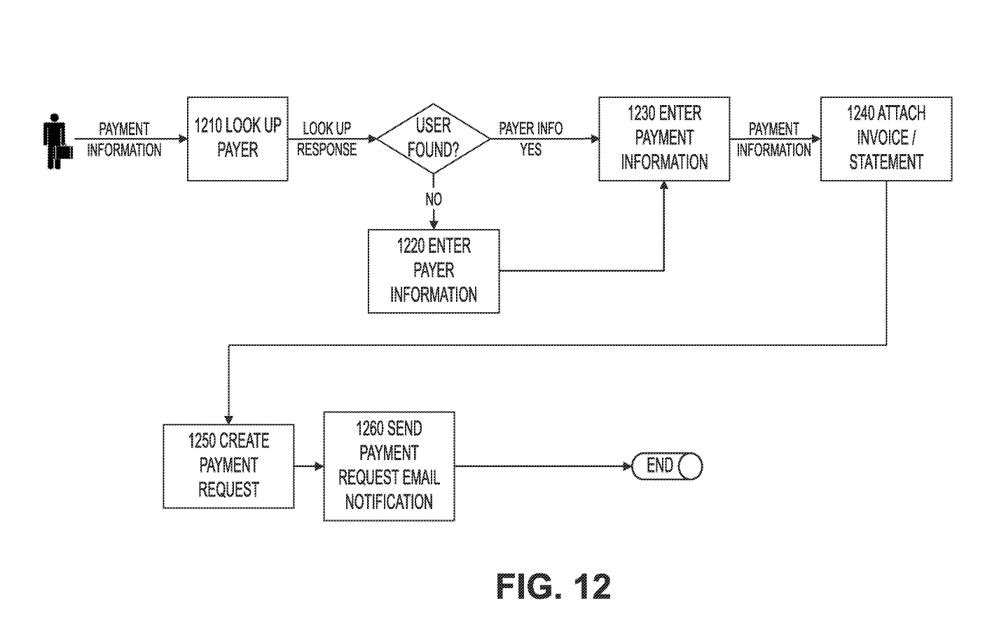

FIG. 12 illustrates making a payment request. At step 1210, Look Up Payer: service provider requires Payer Name, email address and mobile phone number for sending payment requests. If Payer is an existing User, Payee can look-up User by entering any portion of Payer's user name, email address, mobile number, or business name if applicable If the payer has been entered into system previously, service provider application will locate the payer and display their name, address, email and phone number. Multiple payers may appear, and then Payee will select the correct payer from the list. Payee will proceed to 1240. If the payer is not found Payee will proceed to 1230 and enter the Payer into the system.

At step 1220 Enter Payer Information: If Payer is not able to be looked up, Payee will enter the Payer's Name, email, and mobile number into the service provider application. service provider will store User Information in the database as an inactive personal user. The User will be able to process a card through the business user by swiping a card but will be unable to access the system themselves until they complete registration and agree to terms of use.

At step 1230 Enter Payment Information: Payee will enter “amount” to be paid by Payer

At step 1240, Attach Invoice/Statement. Payee will optionally attach invoice or monthly statement.

At step 1250 Create Payment Request: service provider will create a pre-formatted transaction to enable a “no-entry-click-through” transaction for Payer. service provider will link payment request to Payer. Service provider will store payment request in database linked to Payer.

At step 1260, Send Payment Request Email: service provider will send email notification of payment request to Payer.

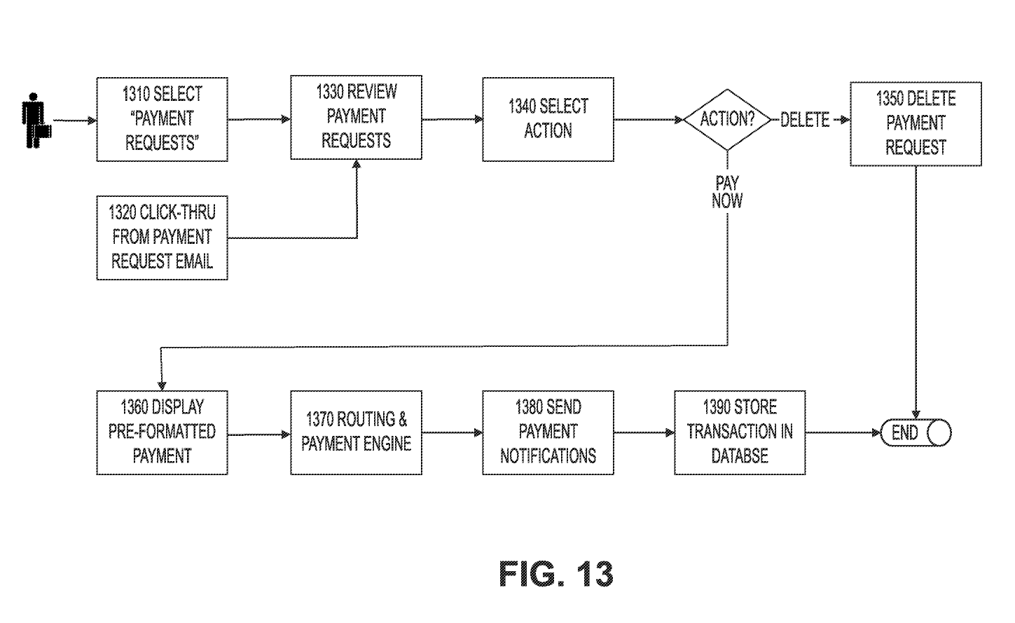

FIG. 13 illustrates making a payment from a payment request clicks on link in email notification. Payer logs in to service provider platform

At step 1310 User Selects Payment Requests: Payer selects Payment Request.

At step 1320 Click-through from Payment Request Email Notification: Payer.

At step 1330 Review Payment Requests: Payer reviews payment requests on PC or mobile device. At step 1340 Select Action: Payer selects Pay Now or Delete.

At step 1350 Delete Payment Request: If Delete is selected, service provider, deletes payment request.

At step 1360 Display Pre-formatted Payment: If Pay Now is selected, service provider displays pre-formatted payment.

At step 1370, Routing & Payment Engine: Service provider sends payment receipt to Payer and to Payee indicating that transaction has been paid with the amount and a reference code.

At step 1380 Send Payment Notifications: Service Provider sends payment receipt to Payer and to Terminal indicating that transaction has been paid with the amount and a reference code.

At step 1390 Store Transaction in Database: Service Provider stores transaction in database.

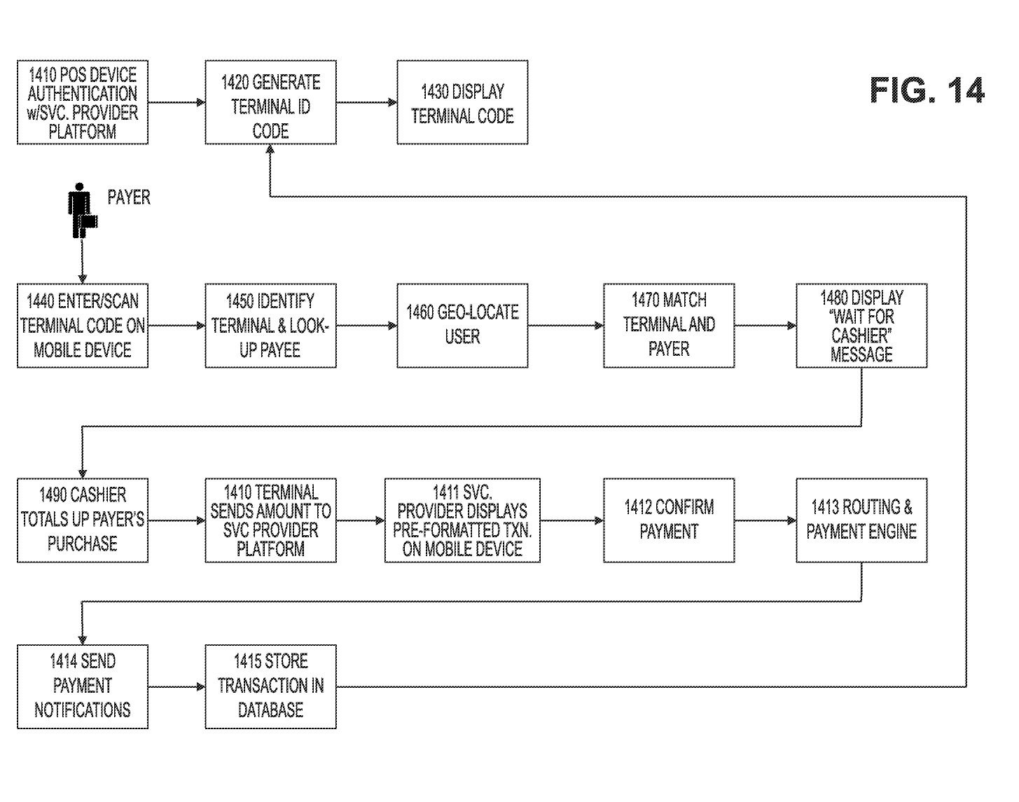

FIG. 14 illustrates accepting payment at retail POS—“Payer brings their own POS—Reverse the Flow”.

At step 1410, POS Device Authentication: POS Device logs in to Service provider platform sending terminal identifier, password, as well as the terminal's unique device fingerprint. Maintains internet connection. Service provider authenticates credentials of terminal, identifies Payee associated with the Terminal, and looks-up geo location of terminal in database.

At step 1420 Generate Terminal ID Code: service provider Platform generates random code associated with that specific terminal to be used for the next transaction. service provider Platform sends code to terminal.

At step 1430, Display Terminal ID Code: Terminal displays code on Terminal Code is available on screen—code just identifies the terminal. Alternatively, the code may be transmitted to a proximity RF tag stuck to the terminal, and/or a bar code may be displayed as well for scanning purposes

At step 1440, Enter/Scan Terminal Code on Mobile Device: Payer enters code, or scans with mobile phone, or reads the RF tag with an RF reader embedded within the phone.

At step 1450 Identify Terminal & Match with Payer and Payee. service provider Platform looks-up Payee, and location of terminal in database. service provider Platform sends message to terminal that the purchase is being made via a mobile device.

At step 1460, Geo-locate User. Service gets geo location of Payer and compares to geo location of terminal to determine that Payer is near terminal At step 1470 Match Payer and Payee: service provider matches Payer to Payee, and links user to terminal. At step 1480, Display “wait for Cashier” Message: Terminal displays “wait for cashier” message. At step 1490 Cashier Totals-Up Transaction: Cashier completes calculation of total amount of purchase as-is done with all purchases.

At step 14100 Terminal Sends Amount to Service Provider Platform: Terminal sends total amount of purchase, time, date, and a reference number for the transaction. At step 14110, Service Provider displays preformatted transaction on mobile device: service provider displays pre-formatted transaction on mobile device.

At step 14120, Confirm Payment: Payer confirms payment.

At step 14130, Routing & Payment Engine: Service Provider authorizes payment.

At step 14140, Send Payment Notifications: Service Provider sends notification to terminal that the payment has been authorized and a payment receipt to Payer and to Payee indicating that transaction has been authorized with the amount and a reference code.

At step 14150 Store Transaction in Database: Service Provider stores transaction in database.

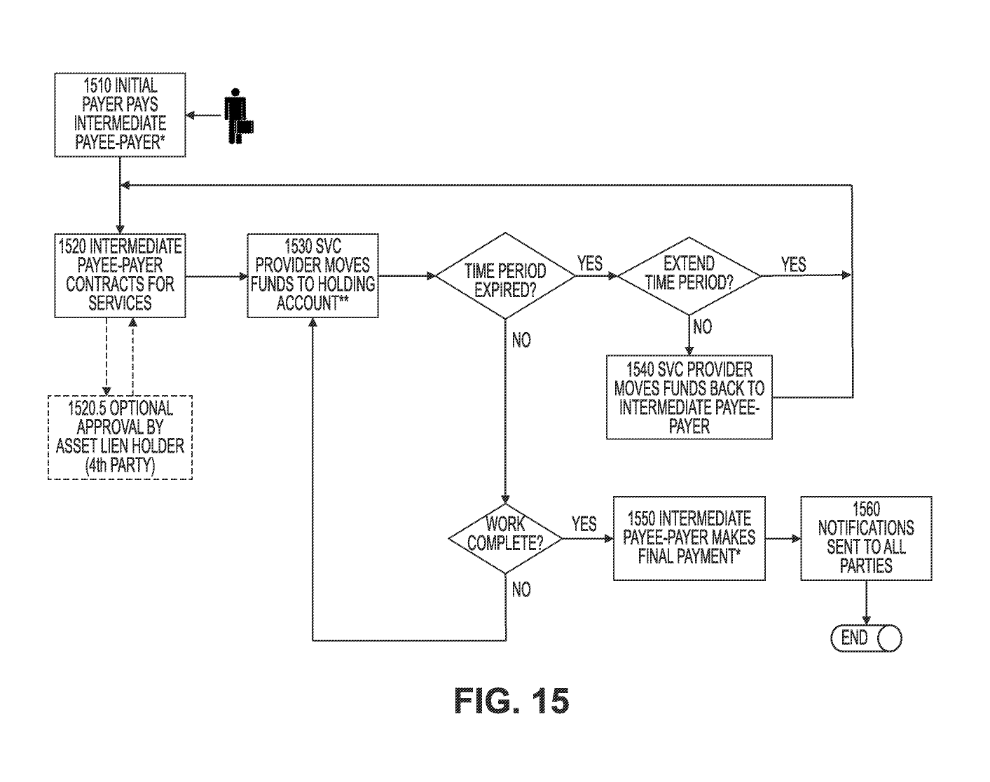

FIG. 15 illustrates 3-Party Payment: Payer→Intermediate Payee-Payer→Final Payee (Insurance Payment). At step 1510 Initial Payer Makes Payment to Intermediate Payer-PayeeInitial Payer authorizes Payment. Service provider makes payment using process of Payment & Routing Engine. Service provider sends Payment Notifications to Payer and Payee. Service provider stores transaction in database.

At step 1520, Intermediate Payee-Payer contracts for Services: Intermediate Payee-Payer contracts for Services (Final Payee). Contract Amount and Contract Expiration Date are entered into the platform. All Parties are linked to the Contract.

At step 1525, Optional Approval by Asset Lien Holder (4^{th} Party): Optionally, it may be required that the asset lien holder (e.g. Mortgage provider), requires the right to approve the contract. In this case, the 4^{th} party would review the contract and select approve in service provider Platform.

At step 1530, Service Provider moves funds to Holding Account: Platform moves funds to Virtual Prepaid Holding Account. The funds are visible to all Parties and are held in the name of the Intermediate Payee-Payer. The funds may only be used to pay the Final Payee, but must first be authorized by the Intermediate Payee-Payer when work is complete. If the contract expires funds are automatically moved back to Intermediate Payee-Payer's Prepaid Debit Account.

At step 1540 Service Provider moves funds back to Intermediate Payer-Payee. If contract expires without authorization to pay Final Payee, funds are moved back to Intermediate Payee-Payer's Prepaid Debit Account.

At step 1550 Intermediate Payer-Payee makes Final Payment: Intermediate Payee-Payer authorizes final payment. Service provider makes payment using process of Payment & Routing Engine. Service provider sends Payment Notifications to Payer and Payee. service provider stores transaction in database

At step 1560 Notifications Sent to all Parties: service provider sends notifications to all parties.

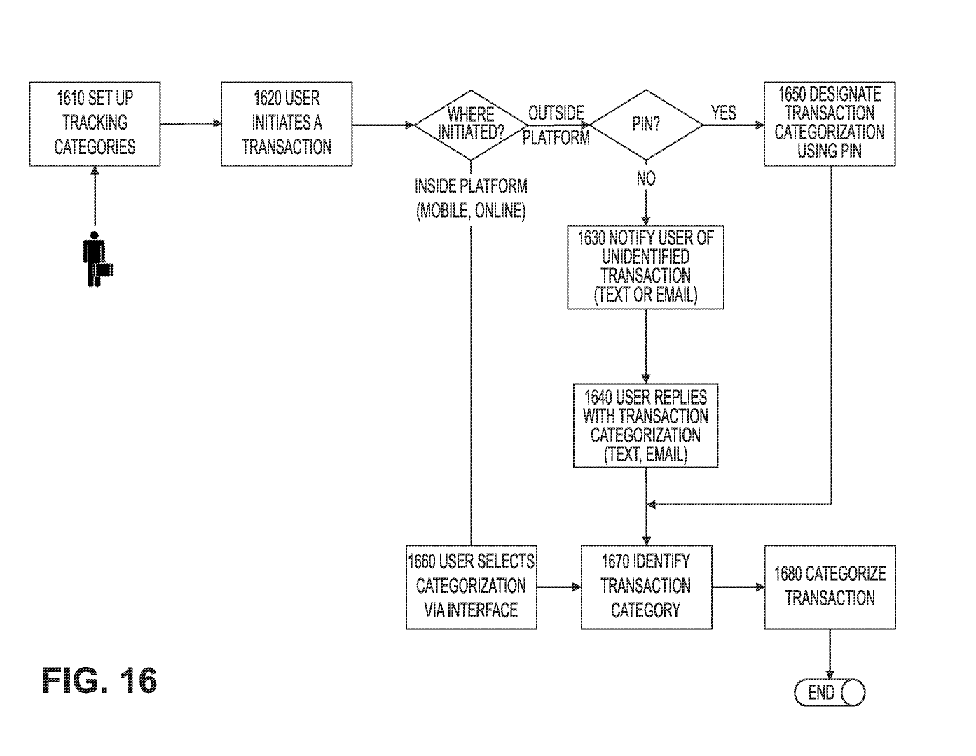

FIG. 16 illustrates tracking and budgeting process. At step 1610 Set-Up Tracking Categories. User sets up tracking categories by providing 4 character short names, long names, PIN Code for the category, messaging preference (email and/or text message) and description. service provider platform enables up to 10 PIN Codes for each service provider Account where each PIN code is linked to a transaction tracking or budgeting category. service provider platform enables PIN codes for categories to be set across all service provider Prepaid Debit Accounts at once (so the user does not have to set up the categories for each account—but the user can have unique categories by account if desired). Also, a “referral link” can be created for each budget category for each customer so that all the user has to do is click that link in the email (“one click”), and it tags that transaction to the category associated with the budget category—which is similar to using a PIN except the referral link is a link instead of a PIN number. Also the system remembers how a user tags items and will default to the most likely category. Further, one can have a choice to split a transaction between more than one budget category.

At step 1620 User Initiates a Transaction: Payer makes a transaction at a retail store, online, or within the service provider Platform.

At step 1630, Notify user of unidentified transaction: If transaction is initiated outside service provider Platform (e.g., Retail Store, Retailer website, etc.), and it not a PIN transaction, then a text message and/or email message (based on User preference) is sent to the user real-time asking for the category. The message contains the 4 character short descriptions set up by the User to be used in the User's response). If the message is an email or an email receipt, it may contain links that are specific to each of the user's budget categories. The user may opt to click the link to categorize the transaction with the specific budget category, or the user may click a link that allows the user to split the transaction between more than one budget category. The categorization will be saved, and used to improve the logic associated with identifying a default categorization for that user.

At step 1640, User reply with transaction categorization. The User replies by either email or text with just the 4 digit short description.

At step 1650, Identify transaction categorization using PIN: If transaction takes place at retail point of sale, and the User selects Debit making the transaction a PIN transactions, the User enters the PIN code at point of sale to designate the category for the transaction.

At step 1660, select categorization using interface: The User logs into the system and categorizes the transaction by entering the 4 character short description next to the transaction in the activity section of the Platform.

At step 1670, Identify Category: service provider Platform reads short 4 character category description from email/text message, PIN from POS, selection from user interface. IF PIN or short description is input, then the input information is matched to Category information provided by User at set-up.

At step 1680 Categorize transactions: Transaction Category is updated in database.

FIGS. 17 and 18 illustrate additional embodiments according to some embodiments of the present application.

FIG. 17 illustrates an exemplary embodiment where a transaction is being performed where a user is allowed to obtain the goods and services and payment is only transmitted after completion of the transfer of the goods/services. One example of this transaction would be obtaining gas from a gas pump.

In block 1702, a customer initiates payment at the merchant terminal. This may be completed by the customer indicating that he wishes to purchase a good or service. For example, at a gas pump, the user may log into the mobile application on his mobile phone so that he is authenticated thereto.

It is noted that each merchant terminal may have a merchant terminal code printed on it. For example, a gas pump may have a number “1234” printed on the gas pump which uniquely identifies the gas pump to the system by location and merchant. All merchant terminal codes from other merchant terminals may be different from each other.

In block 1704, the merchant terminal code of the merchant terminal where the transaction occurs is received by the mobile phone and sent by the mobile phone to the server. For example, the mobile phone may take a picture of the code and decipher the code (e.g., via optical character recognition). In another example, the user may manually input the merchant code into the mobile phone using his mobile application. In yet another example, the mobile phone may obtain the merchant code using low frequency RF transmission (e.g., Bluetooth, NFC). In any case, once the mobile application of the mobile phone obtains the unique merchant terminal code, the merchant code is sent from the user's mobile phone to the server over a network.

Additionally, the mobile phone may send GPS coordinates of the mobile phone along with the merchant code. This may allow the system to verify the location of the merchant terminal.

In block 1706, the merchant terminal code and/or GPS coordinates of the mobile phone are received by the server.

At 1708, the server identifies the merchant terminal using the terminal code and GPS coordinates, preauthorizes the transaction, issues a card token, and initiates a transaction with the merchant terminal. The card token may be a unique number identifying the transaction and is stored at the server (stored card token).

At 1710, a copy of the stored card token and a pre-authorization indication is transmitted to the merchant terminal. At 1712, the customer obtains the merchant's product or service, such as pumping gas. This may occur in direct response to the user initiating the transaction and the merchant terminal receiving the preauthorization indication.

The user is then allowed to receive the merchant goods and services in response to receiving the preauthorization (without the customer having to pay prior to receiving the goods//services).

At block 1714, after the user has received the desired goods/services (e.g., after the user has pumped the desired amount of gas), the merchant terminal receives indication that the user has completed receipt of the goods/services. The transaction amount is determined by the merchant terminal and then the card token and the transaction amount are sent back to the server from the merchant terminal over the network.

In block 1716, a determination is made whether any acknowledgement from the customer on the transaction amount is required. If not, the method continues to block 1720. Otherwise, if acknowledgment of the transaction amount is required from the user, in block 1718, the server sends the amount of the transaction to the mobile phone for customer acknowledgment.

In block 1720, the server then compares the card token receives with a stored card token that is stored at the server at the time of creation of the card token. A determination of whether the received card token matches the stored card token is made at block 1722. If there is no match, an error is presented to the user and server at block 1724. Otherwise, the method may continue to determination block 1723.

At block 1723, a determination is made as to whether the funding account is in-network or not. If not, the method may proceed to block 1725; otherwise, if so, the method may proceed to block 1724.

At block 1724, in response to determining that the card token matches a stored card token and the funding account is in-network, the server completes the transaction by determining the customer account associated with the user associated with the mobile phone, sends funds to the merchant in the amount of the transaction amount, and then debits the customer's account by the transaction amount. The in-network accounts may be accounts that are accounts managed by an owner of the mobile application of the mobile phone as opposed to third party banks.

At block 1725, the transaction authorization is completed via the payment network and issuing back using an out-of-network account associated with the card token, where the out-of-network account relates to a third-party account, such as one owned and managed by a third party banking institution.

At block 1726, (in response to actions of block 1724 or block 1726) the server sends a receipt to both the merchant and the customer via any electronic method, such as email or text message.

FIG. 18 illustrates an exemplary embodiment in which a transaction is being performed where a user must prepay for goods and services and payment is only transmitted prior to the transfer of the goods/services. One example of this transaction would be purchasing clothing from a clothing store.

In block 1802, a customer logs into the mobile application at a merchant terminal where the customer is going to complete a transaction. At this point, the user has selected the goods/services the user wishes to purchase. The goods must be paid for first prior to the transaction being completed.

In block 1804, the merchant terminal code of the merchant terminal where the transaction occurs is received by the mobile phone and sent by the mobile phone to the server. For example, the mobile phone may take a picture of the code and decipher the code (e.g., via optical character recognition). In another example, the user may manually input the merchant code into the mobile phone using his mobile application. In yet another example, the mobile phone may obtain the merchant code using low frequency RF transmission (e.g., Bluetooth). In any case, once the mobile application of the mobile phone obtains the unique merchant terminal code, the merchant code is sent from the user's mobile phone to the server over a network.

Additionally, the mobile phone may send GPS coordinates of the mobile phone along with the merchant code. This may allow the system to verify the location of the merchant terminal.

In block 1806, the merchant terminal code and/or GPS coordinates of the mobile phone are received by the server.

At 1808, the server identifies the merchant terminal using the terminal code and GPS coordinates, preauthorizes the transaction, issues a card token, and initiates a transaction with the merchant terminal. The card token may be a unique number identifying the transaction and is stored at the server (stored card token).

At 1810, a copy of the stored card token and a pre-authorization indication is transmitted to the merchant terminal. At 1812, the customer selects the merchant's product or service, such as clothing, the customer wishes to purchase. This may occur in direct response to the user initiating the transaction and the merchant terminal receiving the preauthorization indication.

The merchant can then determine the transaction amount, such as by “ring up” the goods/services or entering a total amount that the goods/services that were selected by the customer costs.

At block 1814, the transaction amount and the card token is transmitted as a package from the merchant terminal to the server to request prepayment for these goods/services.

In block 1815, in response to the server receiving the package of the transaction amount and the card token from the merchant terminal, the server sends a transaction confirmation request to the customer's mobile application on his mobile phone to request the user confirmation of the transaction and transaction amount. In this regard, the customer receives the transaction confirmation request and the transaction details are presented to the user (e.g., the transaction identification of goods/services being purchased, the merchant, and the transaction amount). The customer can then accept or deny the transaction or transaction amount. For example, the customer can simply indicate on his mobile application of his phone whether he accepts the transaction and transaction amount (e.g., by activating the “yes” or “accept” button presented by the mobile application) or whether he denies the transaction (e.g., by activating the “no” or “deny” button presented by the mobile application). When the customer responds to the transaction confirmation request, the customer's mobile application of the mobile phone receives the input and transmits the customer's reply to the server.

In block 1816, a determination is made whether acceptance of the transaction from the customer is received by the user. If not, the method continues to block 1818. Otherwise, if acceptance of the transaction amount is received from the user, the method may continue to block 1820.

In block 1818, the server receives denial and notifies the merchant terminal of a denial. The method may then return back to block 1812 where the transaction dispute may be resolved between the customer and merchant and the process between 1812 and 1816 may occur again.

In block 1820, the server then compares the card token receives with a stored card token that is stored at the server at the time of creation of the card token. A determination of whether the received card token matches the stored card token is made at block 1822. If there is no match, an error is presented to the user and server at block 1824. Otherwise, the method may continue to determination block 1823.

At block 1823, a determination is made as to whether the funding account is in-network or not. If not, the method may proceed to block 1825; otherwise, if so, the method may proceed to block 1824.

At block 1824, in response to determining that the card token matches a stored card token and the funding account is in-network, the server completes the transaction by determining the customer account associated with the user associated with the mobile phone, sends funds to the merchant in the amount of the transaction amount, and then debits the customer's account by the transaction amount. The in-network accounts may be accounts that are accounts managed by an owner of the mobile application of the mobile phone as opposed to third party banks.

At block 1825, the transaction authorization is completed via the payment network and issuing back using an out-of-network account associated with the card token, where the out-of-network account relates to a third-party account, such as one owned and managed by a third party banking institution.

At block 1826, (in response to actions of block 1824 or block 1826) the server sends a receipt to both the merchant and the customer via any electronic method, such as email or text message.

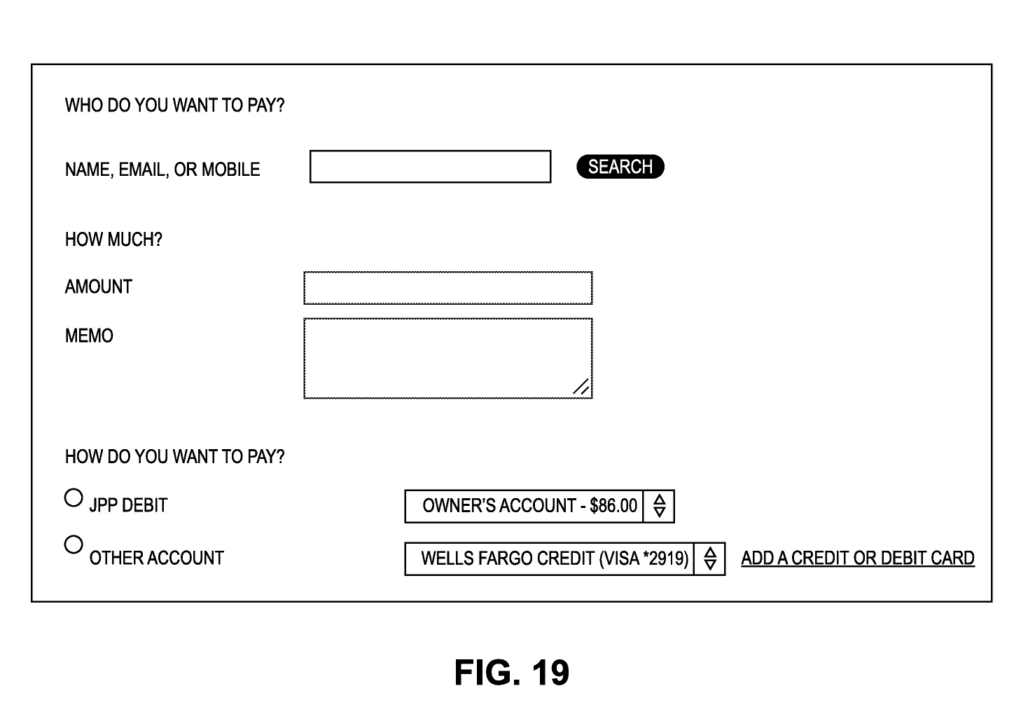

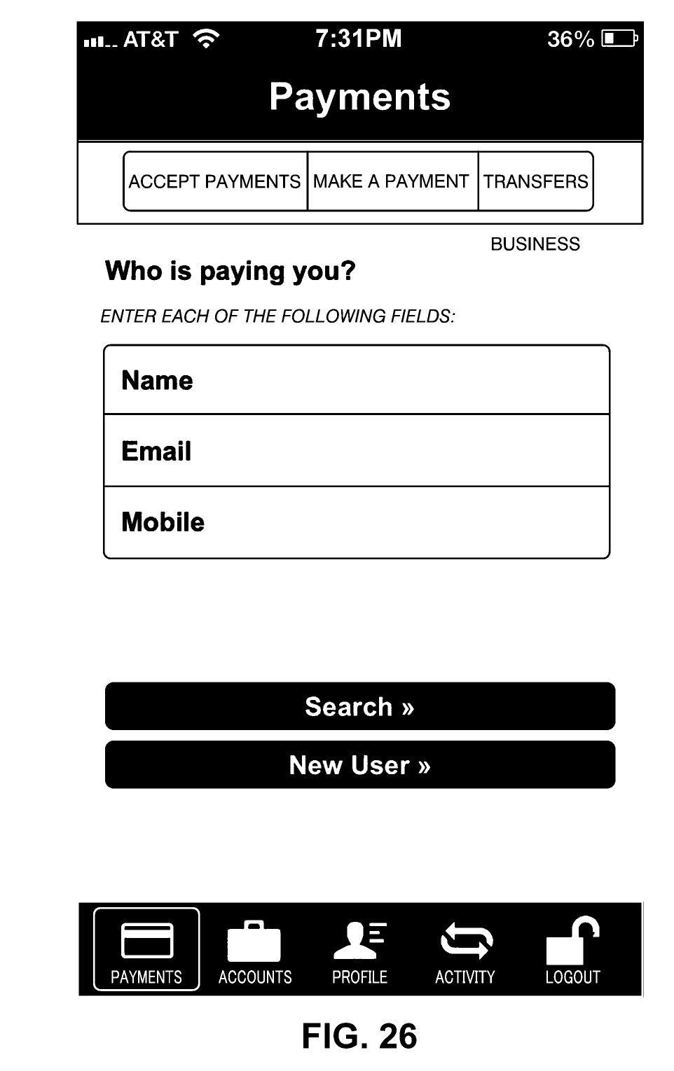

FIG. 19-48 illustrate various exemplary graphical user interfaces (GUIs) of a payment processes in accordance with some embodiments. FIGS. 19-25 illustrate GUIs transferring funds using a computer, and FIGS. 26-43 illustrate GUIs of a mobile application of a mobile phone to facilitate transfer of funds in accordance with some embodiments.

As shown in FIG. 19, a GUI is presented to the user to solicit who (name email or mobile number) to send money to, how much money to send money to send, and which account (either the in-network account or a third party out-of-network account) to send money from.

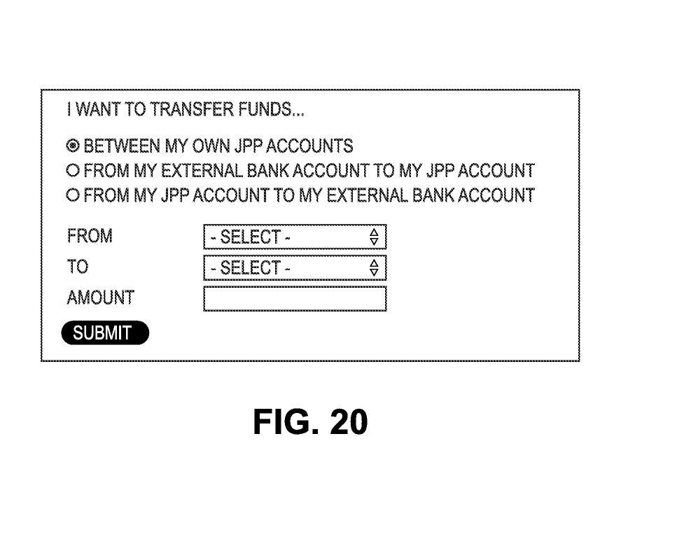

FIG. 20 illustrates a GUI which allows a user to transfer money between in-network accounts owned by the user or transfer money between one of such in-network accounts and a third-party bank account. The user can input the amount and submit such transaction. Funds will then be transferred as requested.

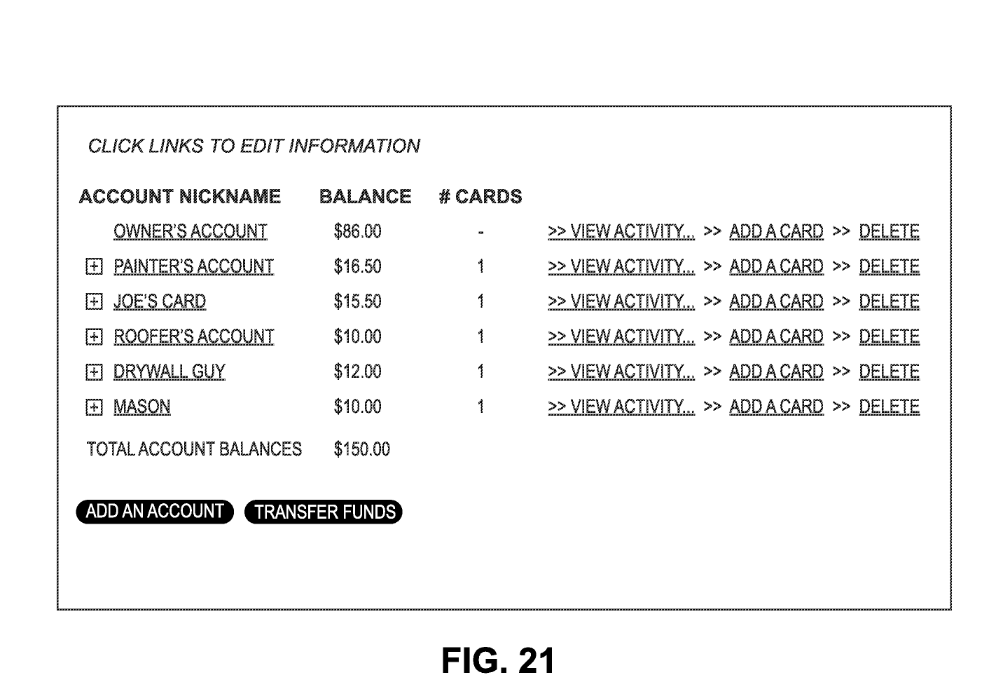

An exemplary listing of accounts is shown in FIG. 21, and the user can view activity of any of the accounts as well as add debit/credit cards to each of the accounts. This GUI allows the user seamless managements of all accounts including credit/debit cards.

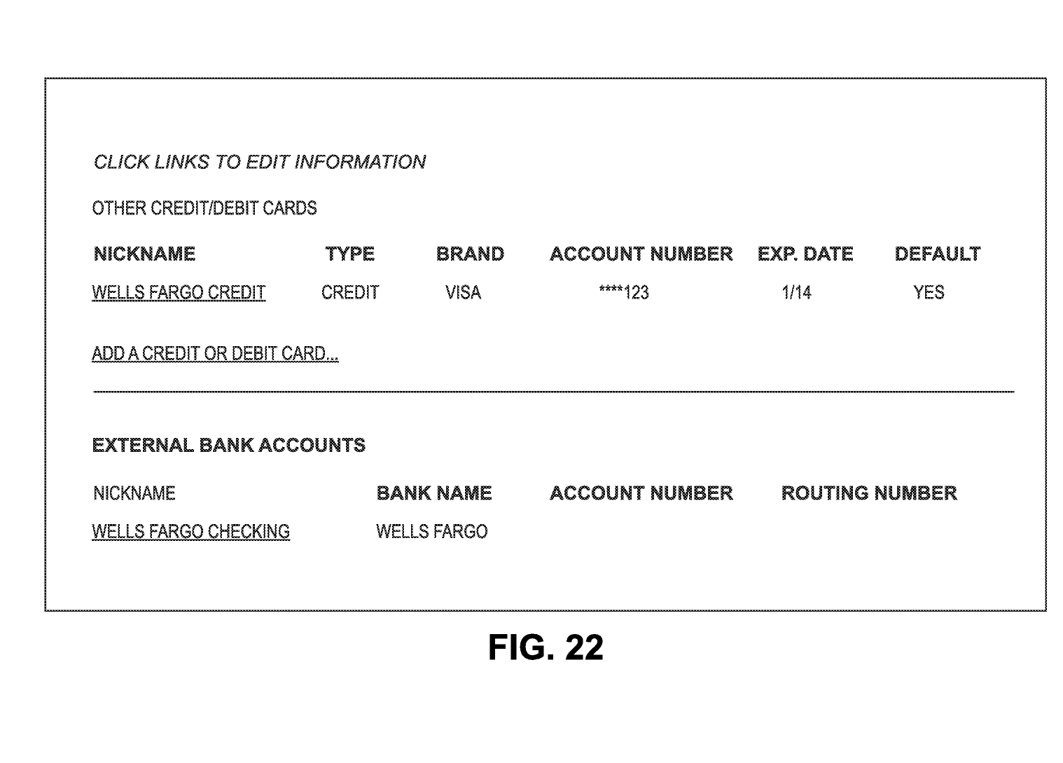

The application may also illustrate a listing of external (i.e., third-party) accounts and credit/debit cards as shown in FIG. 22.

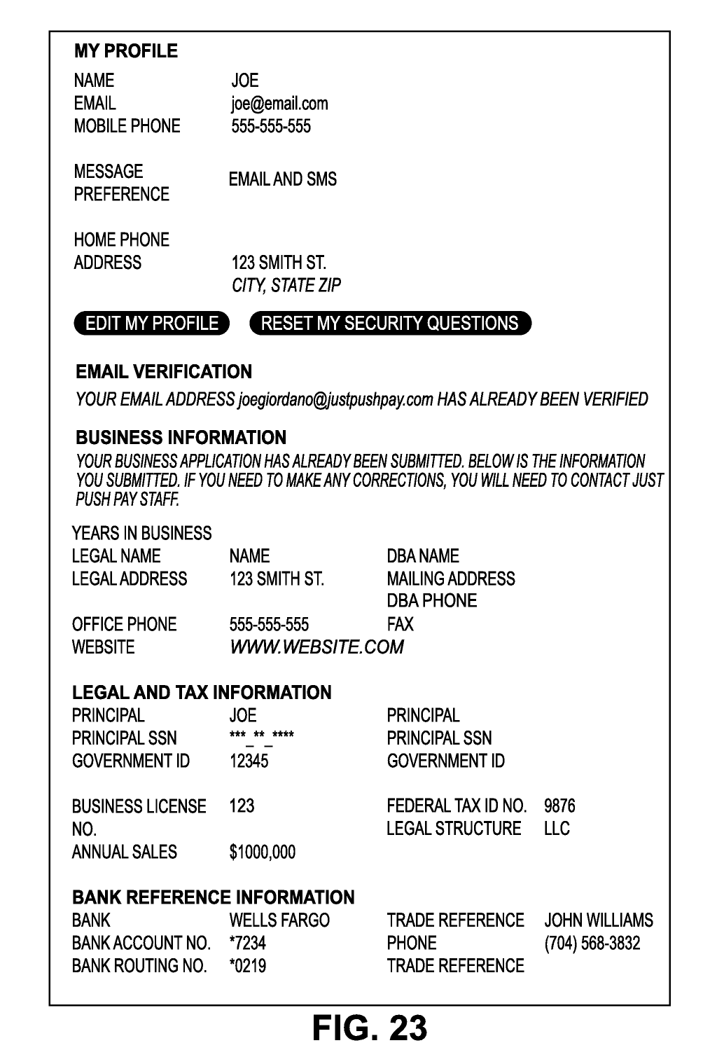

FIG. 23 illustrates a profile in the mobile application and may include email verification information, business information, legal & tax information, and bank reference information.

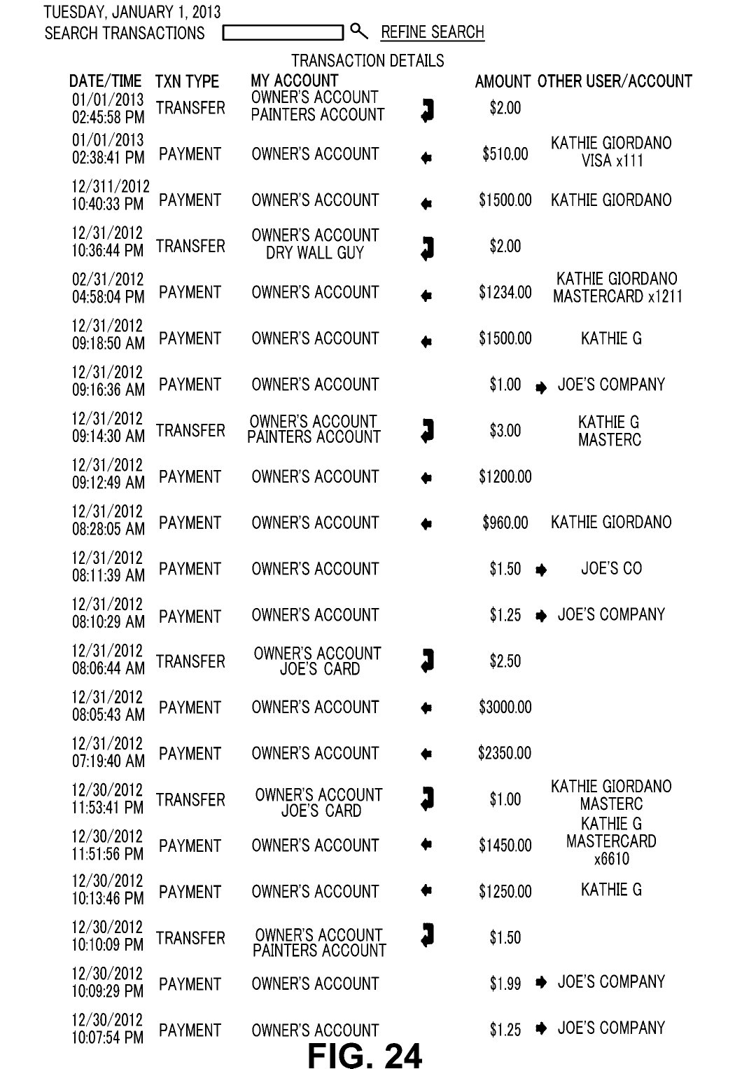

An exemplary transaction history is shown in FIG. 24. The transaction history shows the accounts that the funds have been transferred from and/or to as well as the transaction amounts.

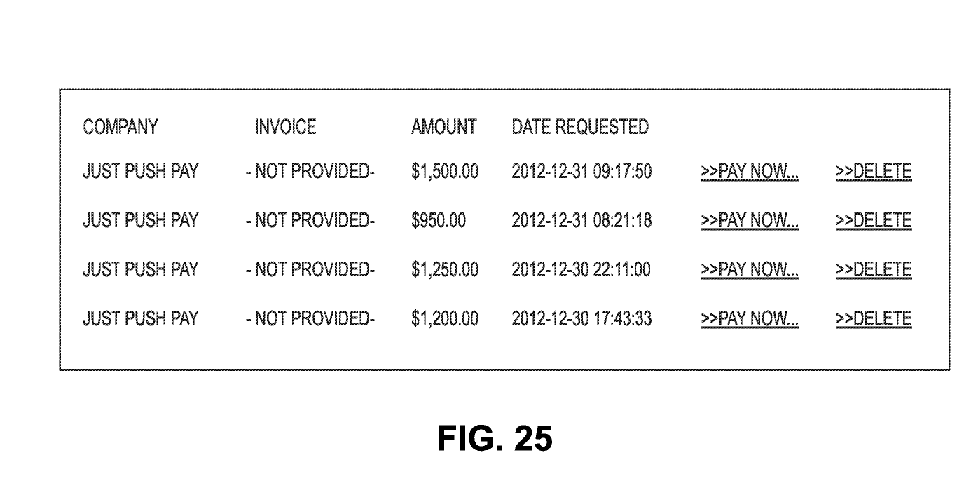

FIG. 25 illustrate pending money requests for a user. As illustrated, one can select which transactions to pay. The user would then be able to pay the requester with the funds from one of the user's in-network or externals account.

As mentioned above FIGS. 26-48 illustrate exemplary GUIs which allow for transfer of funds between accounts or to a merchant.

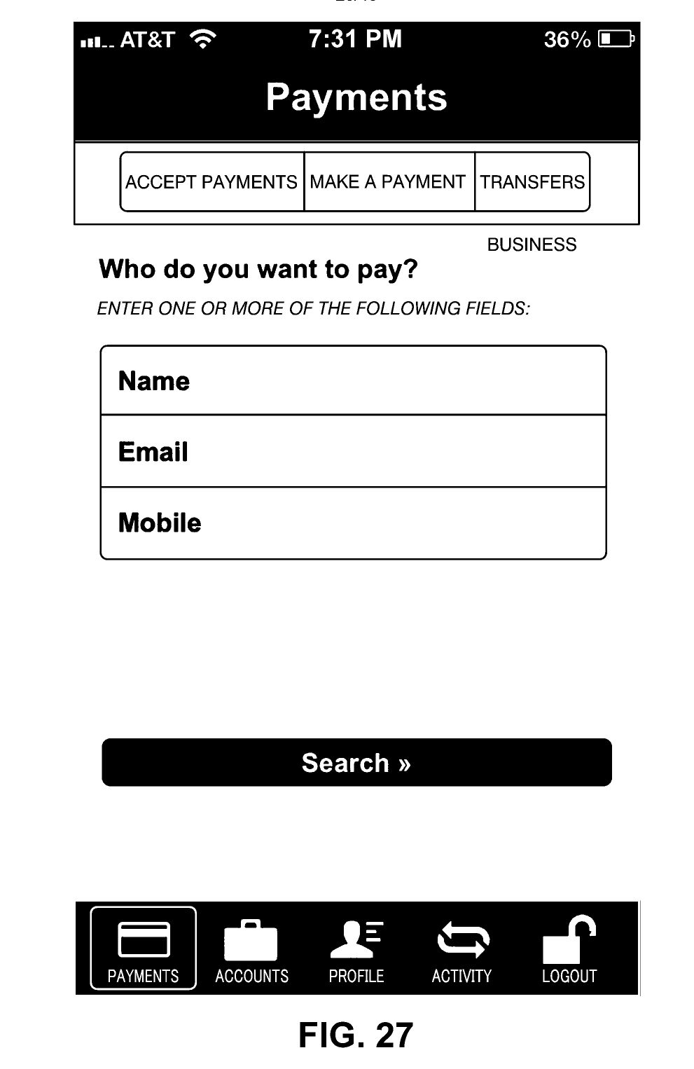

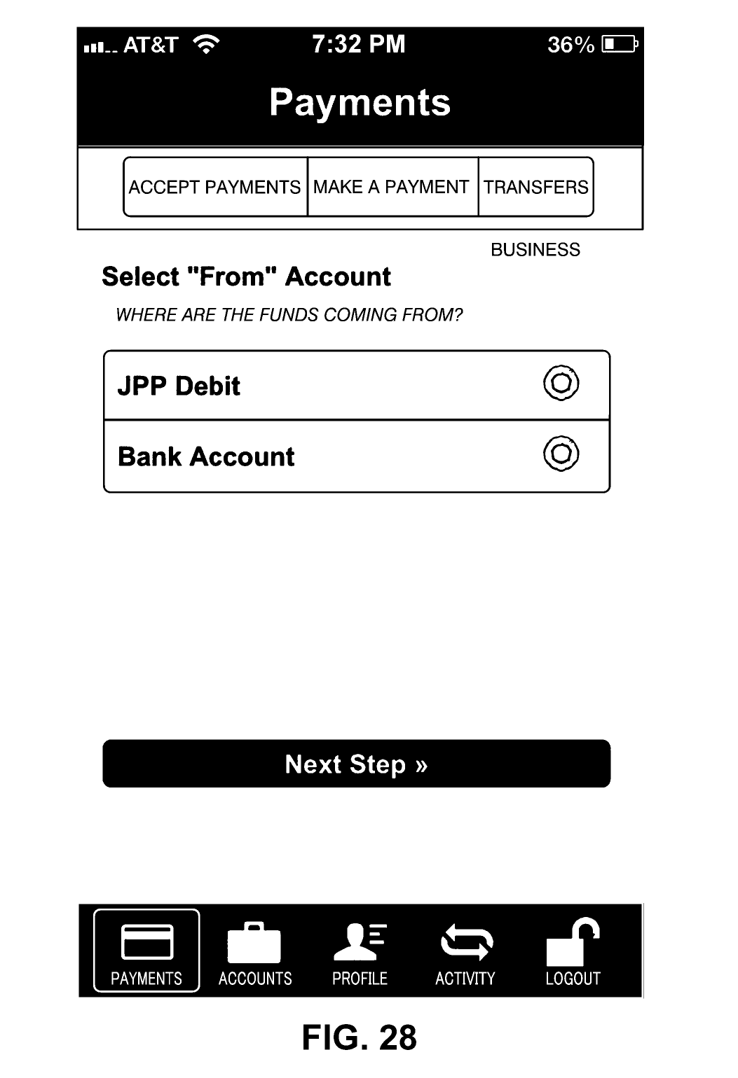

FIG. 26 illustrates a GUI allowing a customer to log into the mobile application. This allows a user to log in as mentioned above for blocks 1702, 1802. FIG. 27 illustrates a mobile application GUI allowing a user to input a person to send money to; and FIG. 28 allows the user to select the accounts to transfer funds to and from.

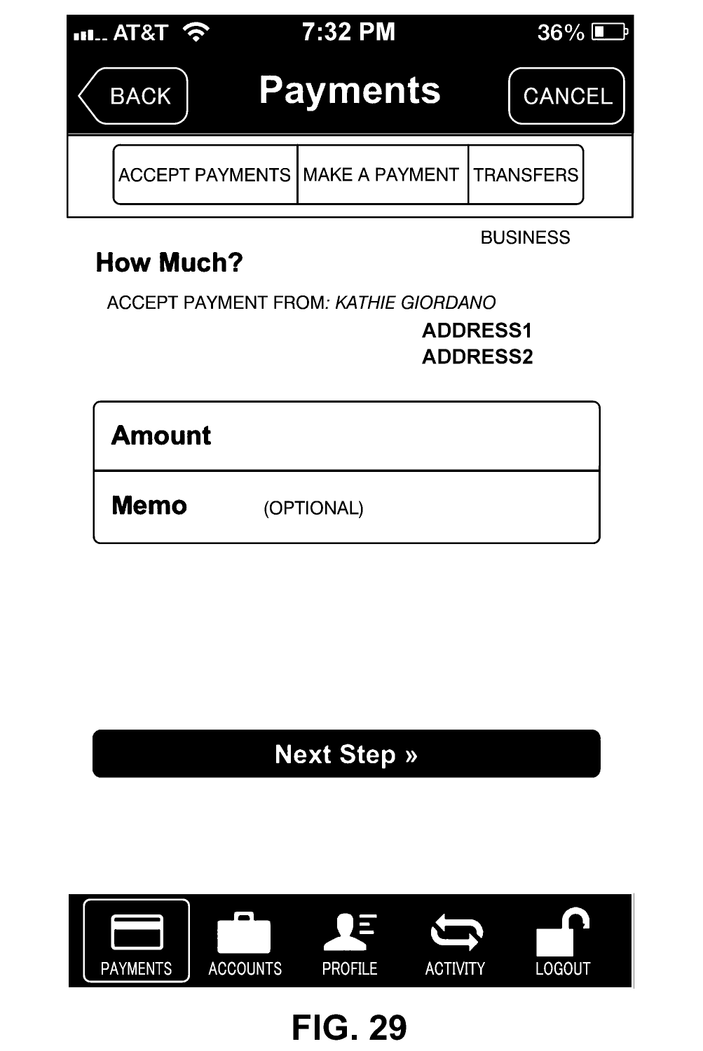

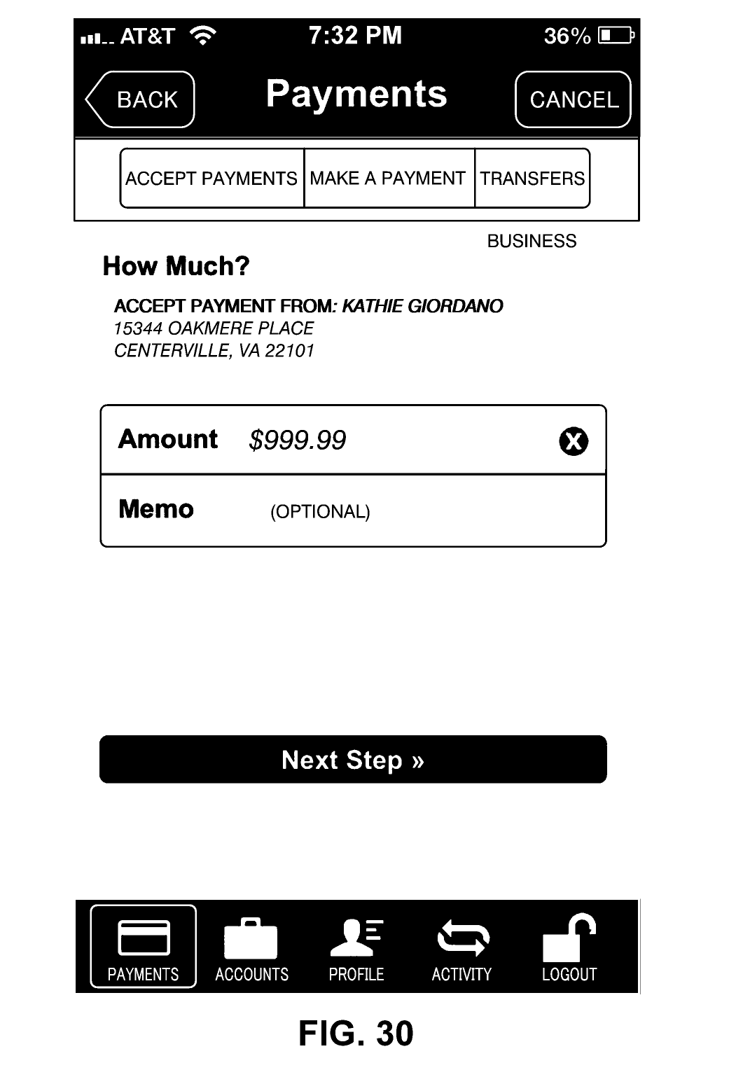

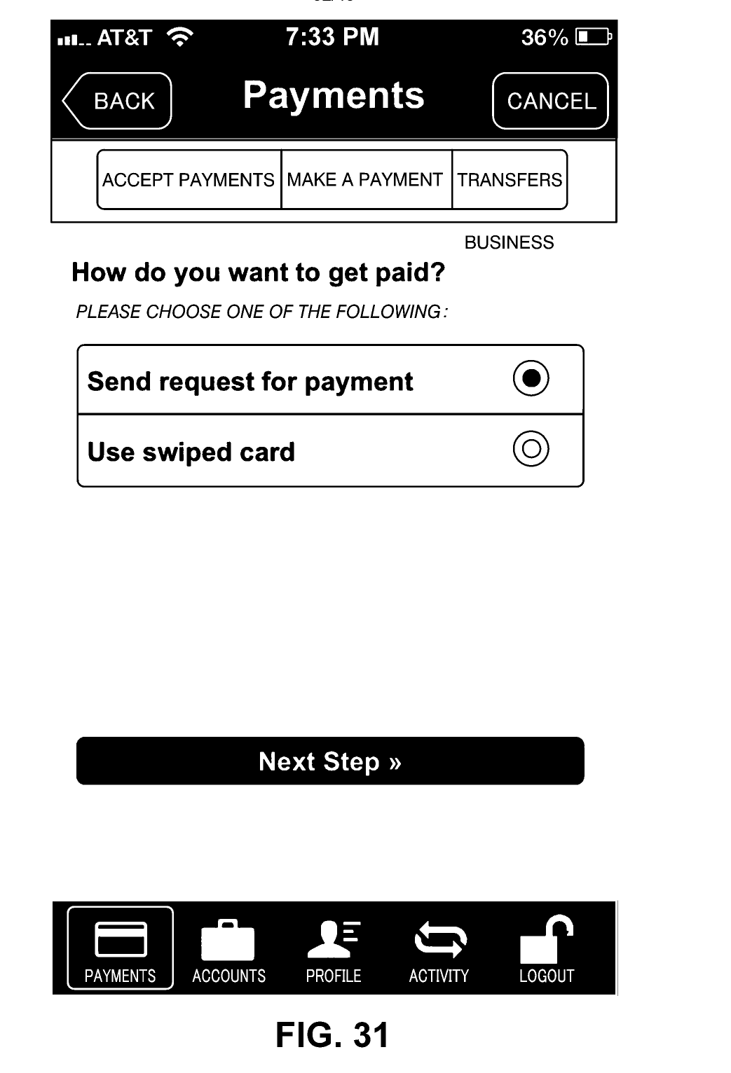

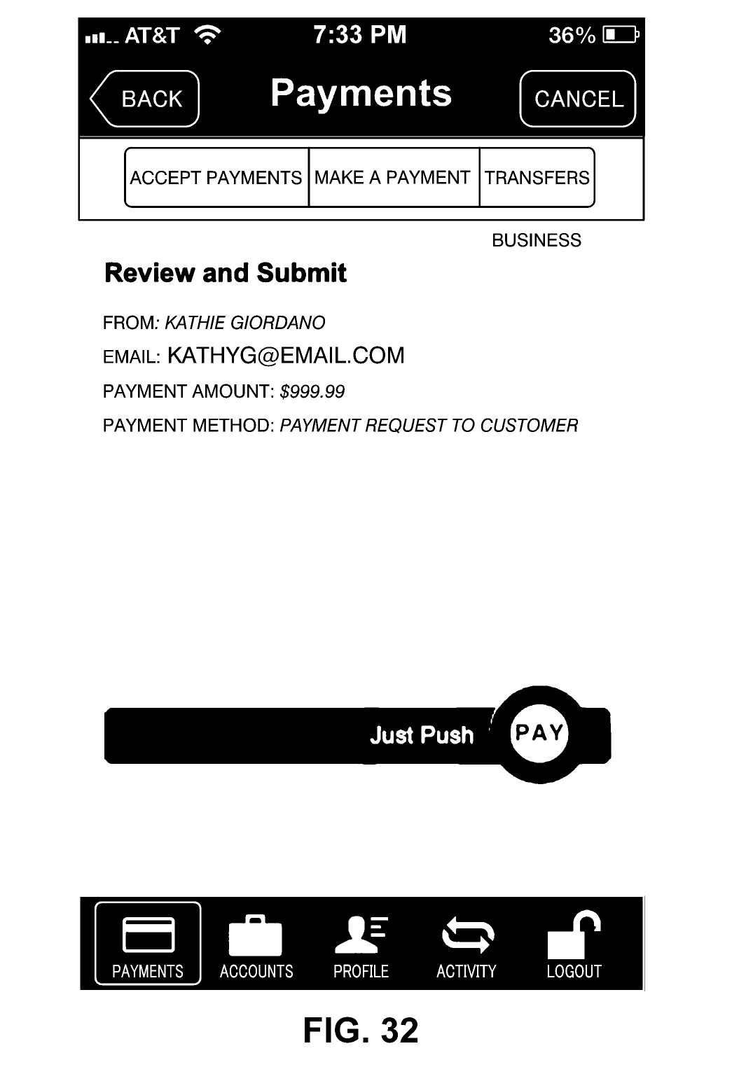

FIGS. 29-32 illustrate an embodiment of sending a request to a requestee to pay the user. FIG. 29 illustrates a mobile application GUI which allows the user to input the requestee's information. The user is then allowed to input the amount of the funds to transfer (FIG. 30 illustrates the amount is $999.99 from Kathie G). As illustrated in FIG. 31, the user can send a request to the requestee (as opposed to selecting the option to obtain payment via a swiped card) for initiating an immediate electronic payment using a credit/debit card. FIG. 32 illustrates a confirmation page which allows the user to then click “pay” to request the payment from the requestee. The requestee will then receive the request for payment electronically.

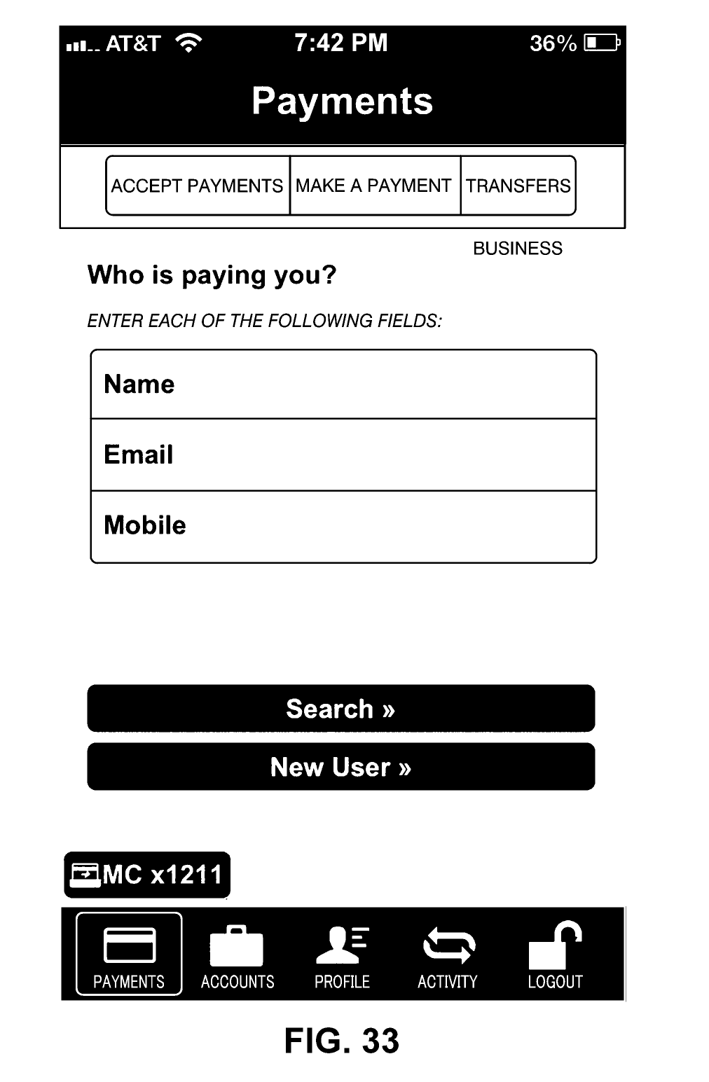

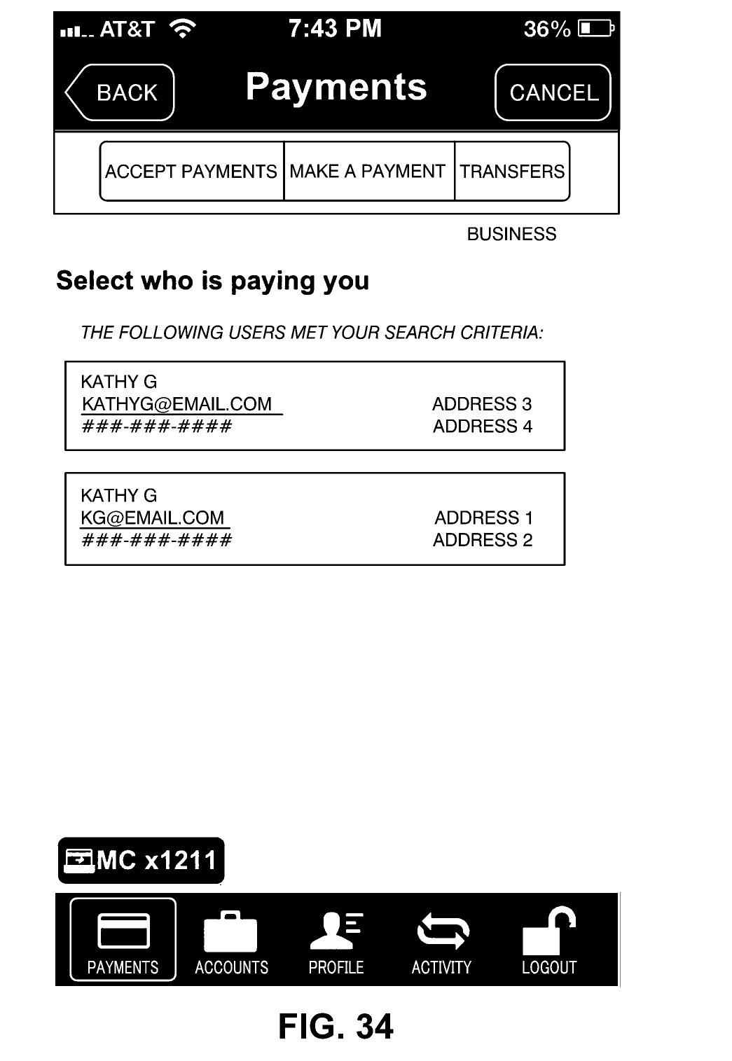

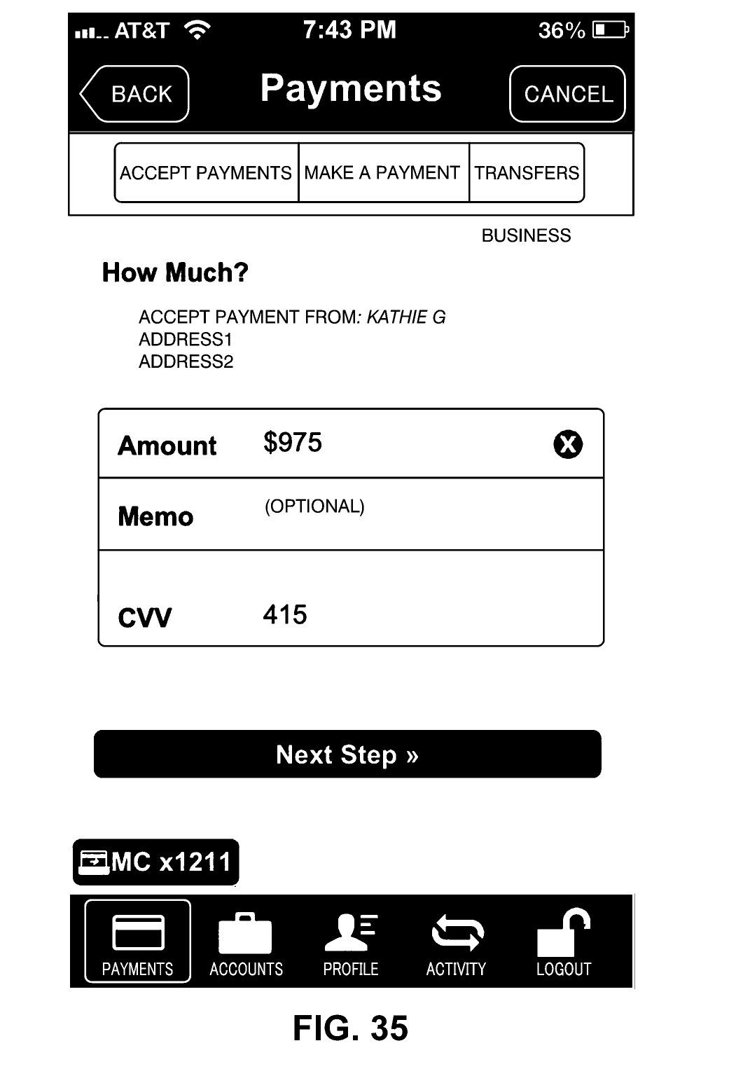

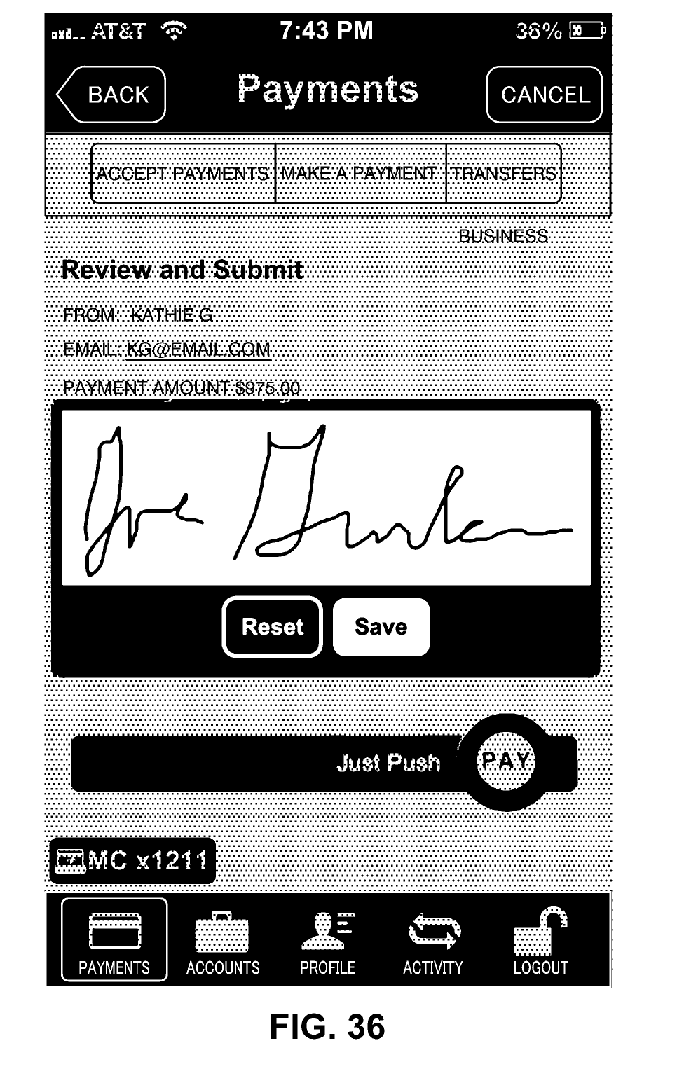

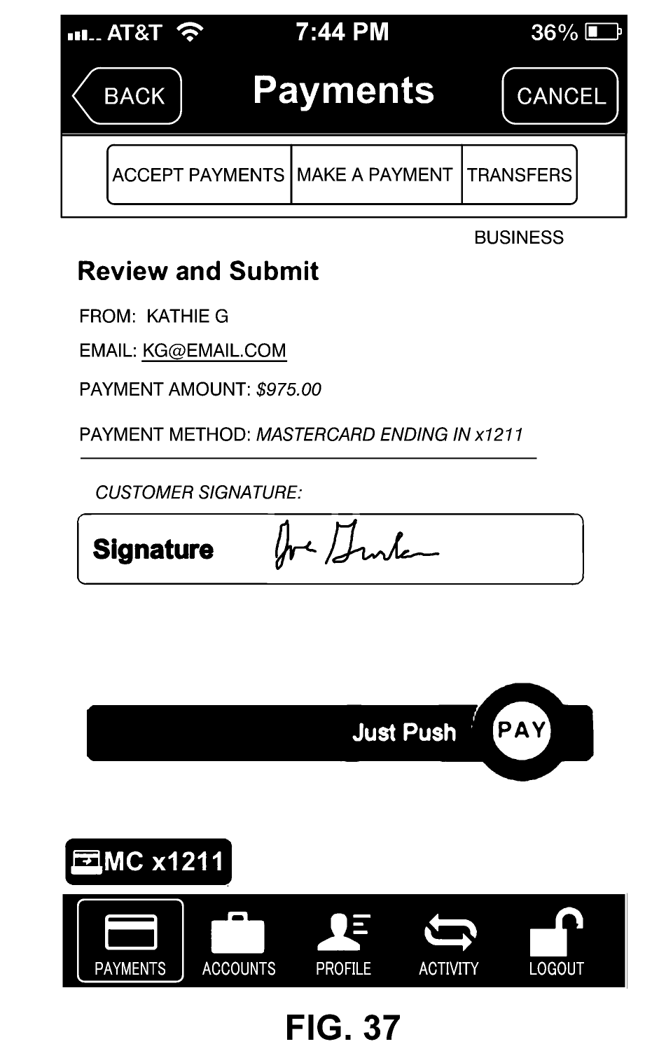

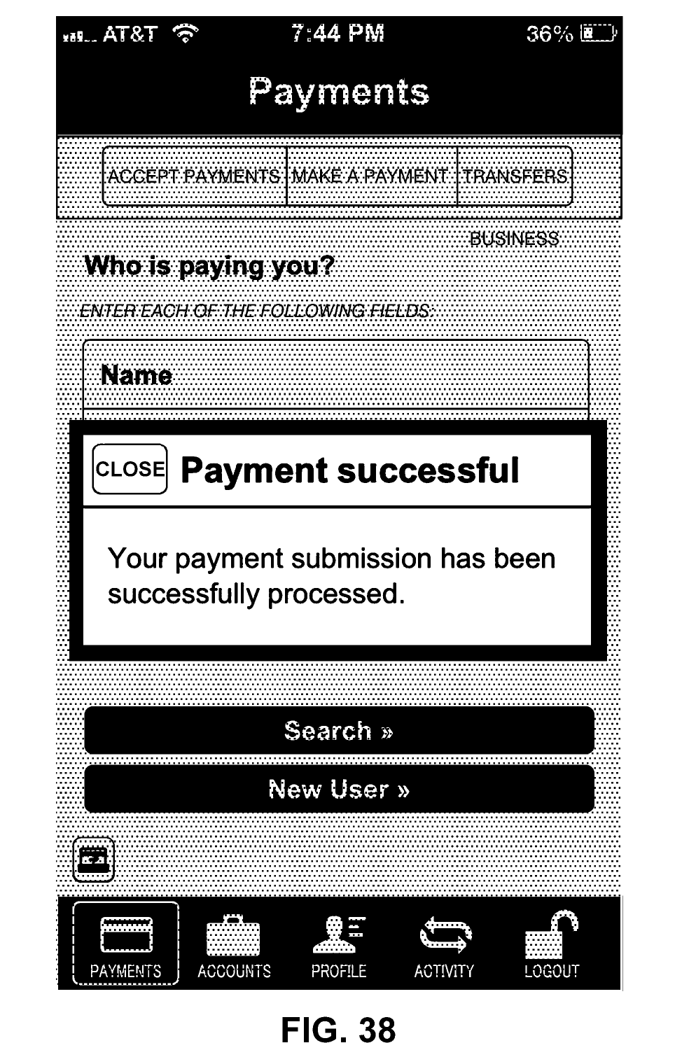

FIGS. 33-38 illustrate another embodiment of requesting a user to pay and the requestee is paying by credit card (instead of sending a request for payment). As illustrated, the user inputs the requestee's information in FIG. 33. The requestee can swipe her card to pay the user. In FIG. 34, a list of potential requestee's are presented to the user and the user can then select one of the requestees. In FIG. 35, the user inputs the amount of payment and the CVV of the card. In FIG. 36, the requestee then signs the user's mobile phone via the mobile application. FIG. 37 is a confirmation page and to initiate the credit/debit card payment. When the user submits the payment, the GUI of FIG. 38 is shown to the user indicating that the credit/debit card payment has been initiated.

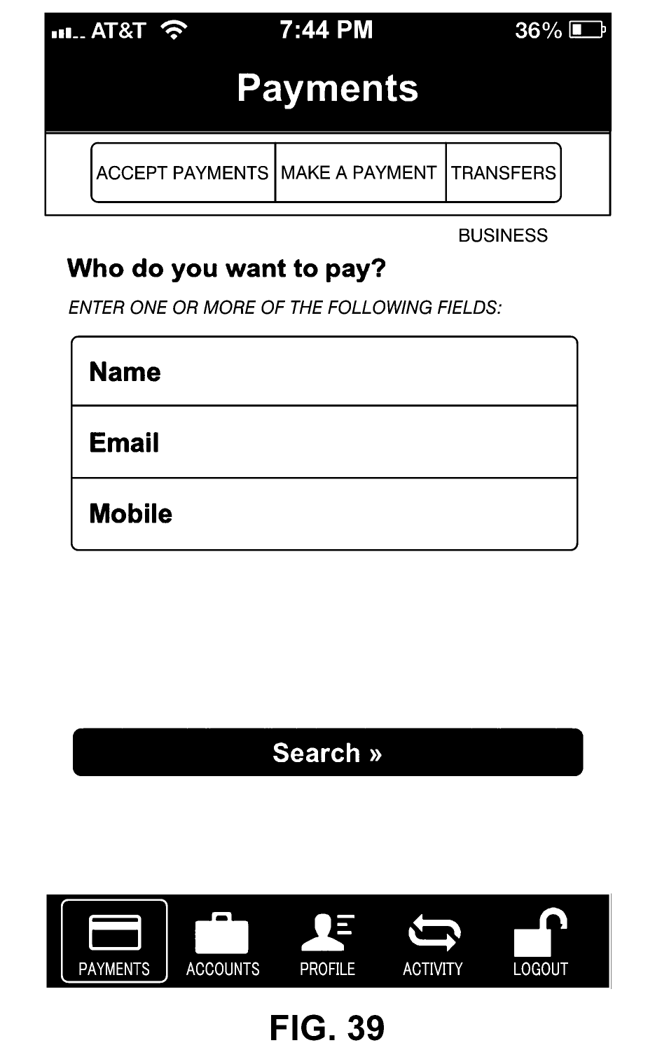

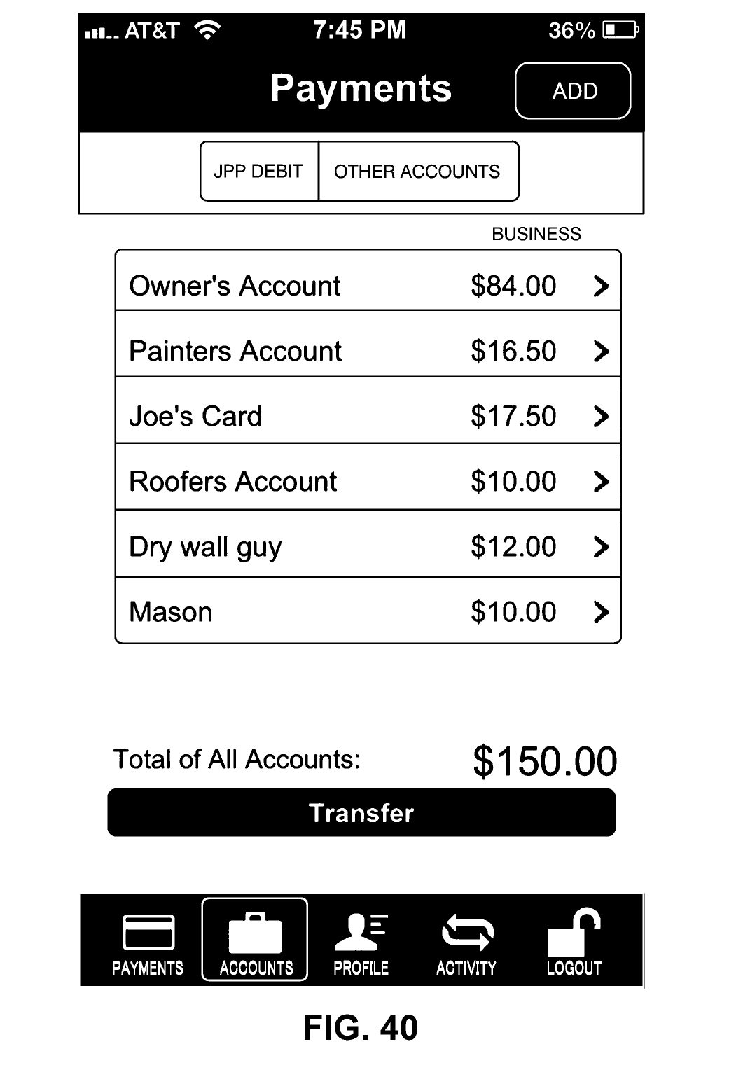

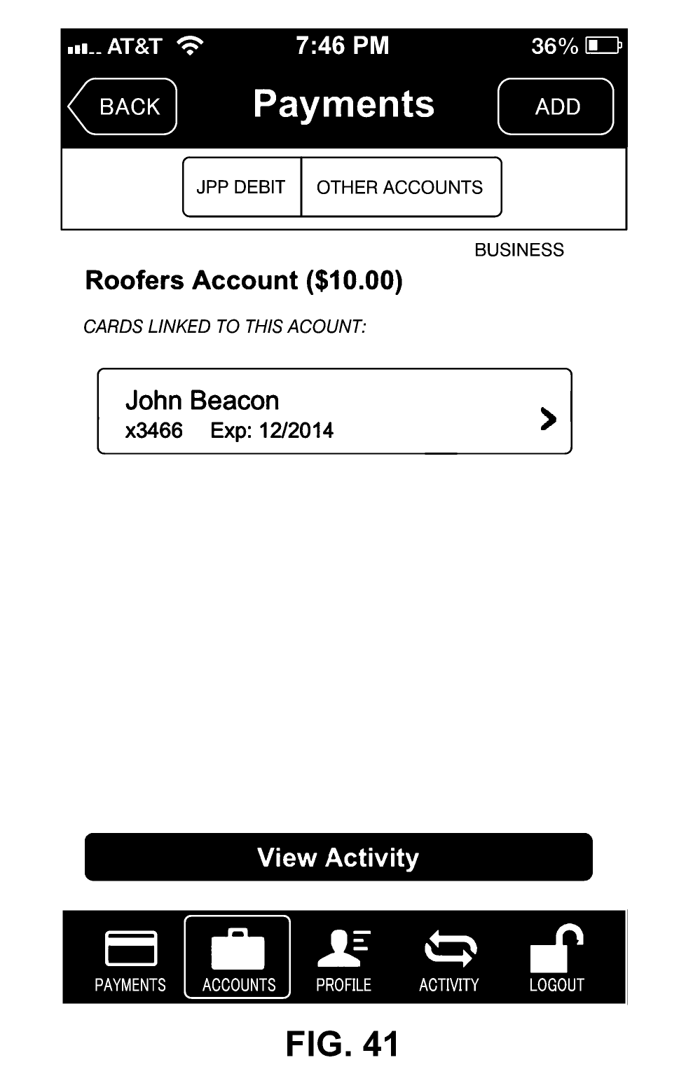

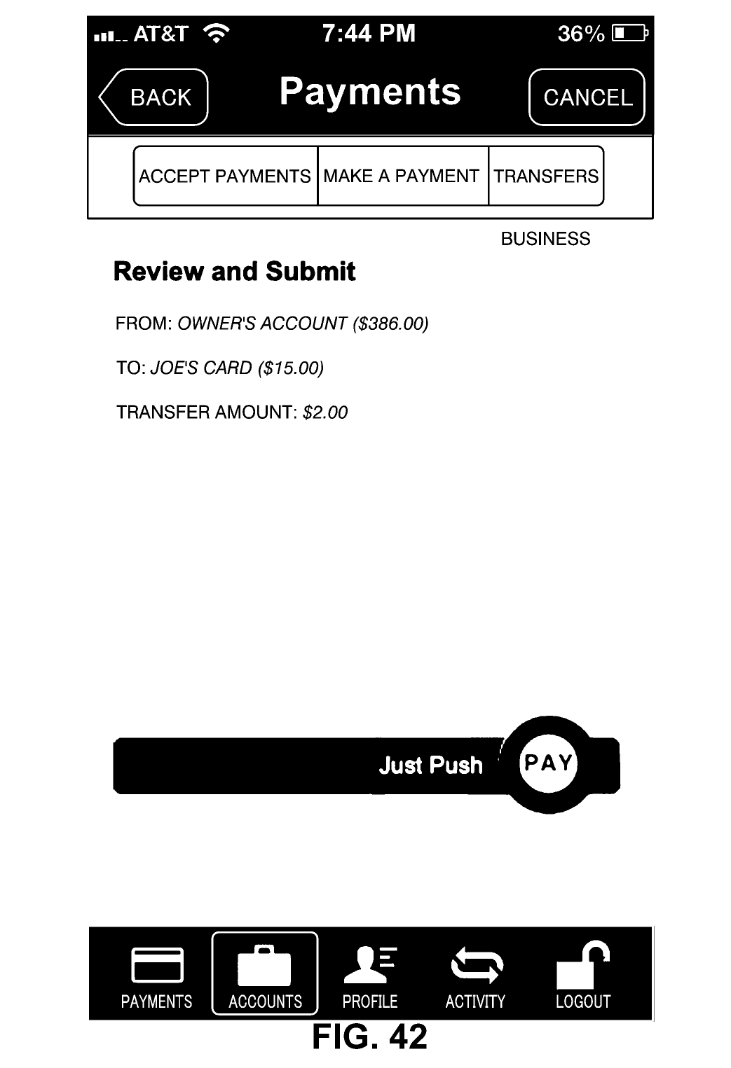

FIGS. 39-42 illustrate a series of GUIs to allow the user to transfer funds. The user selects the person who is desired to be paid (FIG. 39), the user's account is selected (FIG. 40), the payee's account is then selected (FIG. 41), and a confirmation page (FIG. 42) is shown to allow the user to complete the transfer of funds from the user's account to a payee's account.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method of transferring electronic funds from a user to a merchant, the method comprising:
authenticating a user to perform a transaction using a mobile computing device of the user;
receiving an identification of a geographical location of the user's mobile computing device;
generating a user code, by a server, associated with the geographical location of the user's mobile computing device;
storing the user code at the server;
transmitting the user code from the server to the user's mobile computing device so that the user can enter the user code into a terminal of a merchant;
receiving, at the server, a terminal code from the terminal, wherein the terminal code is entered into the terminal;
determining, by the server, if the user code matches the terminal code; sending authorization to the terminal in response to determining that the terminal code matches the user code; receiving a transaction amount and a terminal identifier from the terminal;
determining a geographic location of the terminal based on the terminal identifier; matching the geographic location of the terminal with the geographical location of the user's mobile computing device;
sending a request to the user's mobile computing device to approve the transaction; receiving approval from the user's mobile computing device to authentication the transaction; and
debit user's account of the transaction amount and pay merchant the transaction amount.

2. The method of claim 1, wherein the transaction is performed without swiping a credit or debit card.

3. The method of claim 1, wherein the terminal comprises one of a mobile computing device of an individual or a computing register of a merchant.

4. The method of claim 1, wherein the terminal code is entered into the terminal by the user.

5. The method of claim 1, wherein the matching the geographic location of the terminal with the geographical location of the user's mobile computing device proximate to the geographic location of the terminal.

6. The method of claim 5, further comprising receiving a selection of the transaction from a plurality of transactions within the geographic location of the terminal.

7. A method of transferring electronic funds, the method comprising:
receiving an identification of a geographical location of a user's mobile computing device;
generating a user code, by a server, associated with the geographical location of the user's mobile computing device;
storing the user code at the server; receiving, at the server, a terminal code from the terminal, wherein the terminal code is entered into the terminal by the user; determining, at the server, if the user code matches the terminal code;
receiving a transaction amount and a terminal identifier from the terminal; determining a geographic location of the terminal based on the terminal identifier;
matching the geographic location of the terminal with the geographical location of the user's mobile computing device;
receiving approval from the user's mobile computing device to authentication the transaction; and
debit user's account of the transaction amount and initiate payment of merchant the transaction amount.

8. The method of claim 7, further comprising authenticating a user to perform a transaction using a mobile computing device of the user.

9. The method of claim 7, further comprising transmitting the user code from the server to the user's mobile computing device so that the user can enter the user code into a terminal of a merchant.

10. The method of claim 7, further comprising sending authorization to the terminal in response to determining that the terminal code matching the user code.

11. The method of claim 7, further comprising sending a request to the user's mobile computing device to approve the transaction.

12. A method of transferring electronic funds from a user to a merchant, the method comprising:
authenticating user to an application of a mobile computing device of the user;
displaying a terminal code at terminal of merchant;
receiving the terminal code from the mobile computing device of the user, wherein the terminal code was received by the mobile computing device;
identifying the terminal and look up payee based on the terminal code;
receiving a transaction amount from the terminal;
sending the transaction amount to the user's mobile computing device;
receiving a confirmation of the transaction amount from the user's mobile computing device; and
complete transaction by transferring funds from the user's account to an account of the merchant.

13. A method of transferring electronic funds from a user to a merchant, the method comprising:
receiving user login credentials;
authenticating user to an application of a mobile computing device of the user;
receiving a terminal code at a terminal of merchant;
transmitting the terminal code from the mobile computing device of the user to a server so that the server identifies the terminal and payee based on the terminal code;
receiving a transaction amount from the terminal through the server;
receiving a confirmation request of the transaction amount from the user's mobile computing device; and
complete transaction by transferring funds from the user's account to an account of the merchant.
